(19) United States
(12) Patent Application Publication
(10) Pub. No.: US 2025/0267752 A1
(43) Pub. Date: Aug. 21, 2025

(54) SIGNALING FOR ACTIVATION AND DEACTIVATION OF DISCONTINUOUS COMMUNICATIONS

(71) Applicant: QUALCOMM Incorporated, San Diego, CA (US)

(72) Inventors: Liangping MA, San Diego, CA (US); Hung Dinh LY, San Diego, CA (US); Xiao Feng WANG, San Diego, CA (US); Alberto RICO ALVARINO, San Diego, CA (US)

(21) Appl. No.: 18/444,667

(22) Filed: Feb. 17, 2024

(51) Int. Cl. H04W 76/28

(52) U.S. Cl. CPC H04W 76/28

(57) ABSTRACT

Certain aspects of the present disclosure provide techniques for activating and deactivating cell discontinuous reception (DRX) and cell discontinuous transmission (DTX) operations. For example, a network entity may determine a target time for performing a change in activation or deactivation of a current cell DRX operation at a first cell. In some embodiments, the target time may be determined based on a scheduling time offset associated with the first cell, an indication transmission slot, and a preconfigured delay. Additionally, the network entity may send, to one or more user equipments (UEs) served in the indication transmission slot by the first cell, the target time for performing the change in activation or deactivation of the current cell DRX operation at the first cell. Subsequently, the network entity may perform the change in activation or deactivation of the current cell DRX operation at the first cell at the target time.

### BACKGROUND

### Field of the Disclosure

Aspects of the present disclosure relate to wireless communications, and more particularly, to techniques for activating and deactivating cell discontinuous reception (DRX) and cell discontinuous transmission (DTX) operations.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes determining a target time for performing a change in activation or deactivation of a current cell discontinuous reception (DRX) operation at a first cell, the target time determined based on a scheduling time offset associated with the first cell, an indication transmission slot, and a preconfigured delay; sending, to one or more user equipments (UEs) served in the indication transmission slot by the first cell, the target time for performing the change in activation or deactivation of the current cell DRX operation at the first cell; and performing the change in activation or deactivation of the current cell DRX operation at the first cell at the target time.

Another aspect provides a method for wireless communications by an apparatus. The method includes receiving, from a network entity and in an indication transmission slot, a target time for applying a change in activation or deactivation of a current cell DRX operation at a first cell; and applying the change in activation or deactivation of the current cell DRX operation at the first cell at the target time, wherein the target time for applying the change in activation or deactivation of the current cell DRX operation at the first cell is based on a scheduling time offset associated with the first cell, an indication transmission slot, and a preconfigured delay.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example non-terrestrial network (NTN).

FIG. 6 depicts an example wireless communications system.

FIG. 7A depicts an example of a timeline for cell discontinuous reception (DRX) or cell discontinuous transmission (DTX) activation with a physical time interpretation.

FIG. 7B depicts an example of a timeline for cell DRX or cell DTX activation with a logical time interpretation.

FIG. 7C depicts an example of a timeline for cell DRX or cell DTX activation with a logical time interpretation and different subcarrier spacings (SCSs).

FIG. 8 depicts an example of a cell DRX timeline with a large round-trip time (RTT).

FIG. 9 depicts an example of a cell DRX timeline for a terrestrial network (TN).

FIG. 10 depicts an example timeline with a scheduling time offset for NTN communications.

FIG. 11 depicts an example of a cell DRX timeline for communications with multiple cells.

FIG. 12 depicts an example timeline for cell DRX and cell DTX activation.

FIG. 13 depicts an example timeline with a scheduling time offset for cell DRX and cell DTX activation.

FIG. 14 depicts an example of a cell DRX timeline for communications with multiple cells and using an uplink time synchronization reference point (UTSRP).

FIG. 15 depicts a method for wireless communications.

FIG. 16 depicts another method for wireless communications.

FIG. 17 depicts aspects of an example communications device.

FIG. 18 depicts aspects of an example communications device.

### DETAILED DESCRIPTION

Aspects of the present disclosure provide apparatuses, methods, processing systems, and computer-readable mediums for activating and deactivating cell discontinuous reception (DRX) and cell discontinuous transmission (DTX) operations.

In some cases, current procedures for performing a change in activation or deactivation of a current cell DRX and/or cell DTX operation may be insufficient for wireless communication systems that have a long round-trip time (RTT), long timing advance (TA), long propagation delay, or a combination thereof. For example, data or a message may be in the middle of being transmitted (e.g., the data or message is “in flight” or “in the air”) from a first device to a second device before the first device receives a message to perform or apply an activation of a current cell DRX operation at the second device based on the long RTT, long TA, and/or long propagation delays, such that the data or message arrives at the second device after the second device activates the current cell DRX operation, thereby resulting in the second device not successfully receiving the data or message. Accordingly, as described herein, procedures, techniques, and signaling are provided that delay the change in activation or deactivation of the current cell DRX and/or cell DTX operation to accommodate long RTT, long TA, and/or long propagation delays. For example, a network entity may delay the change in activation or deactivation of the current cell DRX and/or cell DTX operation based on one or more timing offsets.

A wireless communication system may include a number of devices (e.g., terminals, network entities, and other devices) exchanging data, control information, reference signals, etc. (e.g., communicating) with each other. In some examples, a wireless communication system may generally include or refer to a number of devices and network entities employing techniques for exchanging information wirelessly. For example, a wireless communication system may include terminals (e.g., user devices or user equipment (UE)) and network entities (e.g., base stations (BS)) that wirelessly communicate data, control information, reference signals, etc. (e.g., according to various wireless communication system implementations). Devices and network entities operating in a wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, improve the quality of communication between devices and network entities, etc.

As an example described herein, network entities (e.g., a base station) may employ cell DRX operations and/or cell DTX operations to reduce power consumption of the network entities. In cell DRX and cell DTX, the network entities may periodically alternate between an active mode (e.g., “ON” period) and an inactive mode (e.g., “OFF” period). During the inactive mode of cell DTX, the network entity may turn off the transmission of certain signals such as semi-persistent scheduling (SPS) transmissions, UE specific search space (USS) physical downlink control channel (PDCCH) transmissions, PDCCH with downlink control information (DCI) format 2_m (e.g., where m=0, 1, 2, 3, 4, 5, etc.), and periodic or semi-persistent channel state information (CSI)-reference signal (RS) transmissions for CSI reports. During the inactive mode of cell DRX, the network entity may turn off the reception of certain signals such as configured grant (CG) signals, scheduling requests (SRs), periodic or semi-persistent sounding reference signal (SRS) CSI reports, and periodic or semi-persistent SRSs. inactive

In some examples, cell DRX and cell DTX may be employed based on parameters configured by the network. For example, the network may configure timing information (e.g., durations of the active modes and the inactive modes, periodicity, etc.) based on semi-static signaling (e.g., radio resource control (RRC) signaling) or dynamic signaling. Additionally or alternatively, the network may activate and/or deactivate the cell DRX and cell DTX (e.g., indicate a change in activation or deactivation of a cell DRX or cell DTX operation) based on transmitting a message (e.g., downlink control information (DCI) message, a medium access control (MAC) control element (CE) message, etc.) to a device.

After transmitting or receiving the message that activates and/or deactivates the cell DRX or cell DTX operations, the network entity employing the cell DRX or cell DTX may then accordingly perform the change in activation or deactivation for the cell DRX or cell DTX after, for example, a configured delay (e.g., a preconfigured or dynamically configured delay). For example, if a network entity is employing the cell DRX or cell DTX, the network entity may perform the change (e.g., activate or deactivate) for the cell DRX or cell DTX at the network entity based on the configured delay after transmitting a message for the change, and an additional device (e.g., terminal device, UE, or other network entity) that receives the change message may apply the change to activate or deactivate the cell DRX or cell DTX for the network entity based on the configured delay. The configured delay is intended to ensure that the network entity and additional device are synchronized for performing or applying the change in activation or deactivation of the cell DRX or cell DTX or determining the change in activation or deactivation of the cell DRX or cell DTX has occurred at the network entity at a same or approximately same time. In some embodiments, the configured delay is an integer number of slots, where the integer number depends on a subcarrier spacing (SCS) of communications for the network entity. In some embodiments, the configured delay is in terms of a time duration (e.g., y milliseconds (ms), where y is an integer or a fraction).

Technical problems for performing or applying a change in activating or deactivating cell DRX and/or cell DTX include, for example, the configured delay being insufficient for wireless communication systems that have a long RTT, long TA, and/or long propagation delay. In some cases, the delay between the network entity transmitting the message to perform or apply the change in activating or deactivating the cell DRX or cell DTX and then performing the change may be insufficient for the device receiving the message to apply the change appropriately. For example, signal propagation time and/or RTT may increase as the distance between the network entity and the device increases, where the signal propagation time or the RTT can be greater than the configured delay. As such, if the distance between the network entity and the device is relatively far (e.g., such as in a non-terrestrial network (NTN), where the network entity is airborne or spaceborne, such as a satellite or a part of a satellite), the device may receive the message to perform or apply the change in activating or deactivating the cell DRX or cell DTX too late (e.g., based on a large propagation delay and/or large RTT between the network entity and the device) for the device to appropriately apply the change for the network entity even when the network entity implements the configured delay before applying the change.

As an example, the device may attempt to transmit data or an additional message to the network entity before receiving the message to apply an activation of a cell DRX operation at the network entity. In some cases, the configured delay described previously between the network entity transmitting the message to apply the activation of the cell DRX operation and then performing the activation of the cell DRX operation is sufficient for such situations, and the network entity can receive the data or additional message (e.g., during a duration of the preconfigured delay).

However, when the network entity and the device are far apart from each other, the network entity may perform the activation of the cell DRX operation to enter a corresponding inactive duration of the cell DRX operation (e.g., after waiting the preconfigured delay) while the data or additional message is still in the process of being transmitted (e.g., the data or additional message is in flight to the network entity). Consequently, the data or additional message may arrive at the network entity while the network entity is in an inactive duration of the cell DRX, thereby resulting in the data or additional message not being received or processed at the network entity.

As described herein, a technical solution (e.g., techniques and signaling) is provided to overcome the aforementioned technical problem(s). For example, the technical solution may include a network entity delaying activation or deactivation of a current cell DRX and/or cell DTX operation by one or more additional timing offsets (e.g., in addition to the preconfigured delay) to mitigate the aforementioned technical problem(s). For example, the one or more additional timing offsets may include a scheduling time offset associated with the network entity (e.g., a cell-specific scheduling time offset), a timing offset corresponding to a downlink and uplink frame alignment offset (e.g., an offset denoting a difference in alignment between downlink slots and uplink slots at the network entity, which may further represent a RTT between the device and a synchronization reference point), an additional slot, a delay incurred from possible retransmissions (e.g., a maximum number of MAC-CE retransmissions), or a combination thereof. Accordingly, the activation or deactivation of a current cell DRX and/or cell DTX operation may occur or may be expected to occur at the beginning of a target slot that is a first slot whose beginning is no earlier than (e.g., same or after) a beginning of an indication transmission slot (e.g., a slot in which a message indicating cell DTX or cell DRX activation/deactivation is received) plus the preconfigured delay plus the one or more additional timing offsets.

In some embodiments, the technical solution may include the network entity indicating a target time (e.g., the target slot) for performing (e.g., at the network entity) or applying (e.g., at one or more terminal devices) a change in activation or deactivation of a current cell DRX and/or cell DTX operation to one or more terminal devices (e.g., one or more UEs) served by the network entity, where the target time is determined based on the one or more additional timing offsets. For example, the network entity may send the one or more additional timing offsets to the one or more terminal devices (e.g., sent in a system information block (SIB), such as during initial access), and the one or more terminal devices may be expected to apply the change in activation or deactivation of a current cell DRX and/or cell DTX operation at the target time according to the one or more additional timing offsets after receiving a message (e.g., a DCI format 2_9 or a MAC-CE) in the indication transmission slot from the network entity indicating the change. Additionally or alternatively, the technical solution may include that the network entity may indicate the target time based on sending an absolute time for performing or applying the change (e.g., in a SIB) to the one or more terminal devices, and the one or more terminal devices may assume the change in activation or deactivation of the current cell DRX or cell DTX operation is performed by the network entity at the absolute time after receiving the message in the indication transmission slot indicating the change. For example, the absolute time may be indicated by a system frame number (SFN), subframe number, slot number, and symbol index.

Additionally, in some cases, a downlink time offset between two cells originated from different network entities (e.g., base stations) may be different among multiple terminal devices (e.g., multiple UEs), and the different downlink time offsets may be unknown to the network. Accordingly, based on the technical solution provided herein by delaying the change in activation or deactivation of a current cell DRX and/or cell DTX operation using the one or more additional timing offsets (e.g., which may be cell-specific across multiple terminal devices or UEs served by the cell and not specific to each terminal device or UE) and/or indicating the absolute time for performing or applying the change, the issue of different time offsets among the multiple terminal devices may be mitigated. Additionally or alternatively, a synchronization reference point (e.g., an Uplink Time Synchronization Reference Point (UTSRP), Uplink Synchronization Reference Point (ULSRP), etc., where uplink and downlink time slots are aligned) for each cell may be used for determining the target time for performing and/or applying the change in activation or deactivation of a current cell DRX and/or cell DTX operation to mitigate, for example, the issue of different time offsets between two cells originating from different network entities.

In some embodiments, as part of the technical problem(s) described herein, the network entity and the device may be part of a non-terrestrial network (NTN), and the network entity may be a spaceborne (e.g., satellite) or airborne (e.g., airship, balloon, etc.) platform or a part of such a platform that is far away from the device, where an RTT for communications between the network entity and the device can be a relatively long duration (e.g., 500 milliseconds for a geosynchronous equatorial orbit (GEO)). Additionally or alternatively, the network entity may be a base station on the ground that is far from the device (e.g., resulting in a long RTT, long TA, etc.).

As described herein, the technical solution provided may generally include, when a device (e.g., UE) receives in a slot m on an active downlink (DL) bandwidth part (BWP) of a first serving cell (e.g., a first cell) a PDCCH providing DCI format 2_9 (e.g., or another message, such as a MAC-CE) that indicates a change in activation or deactivation of a current cell DRX operation for a second serving cell (e.g., a second cell), the device operates on the second serving cell according to the indicated cell DRX operation starting from a slot on an active uplink (UL) BWP of the second serving cell that is not before the beginning of a slot m+d+K_{cell,offset}·24 on the active DL BWP of the first serving cell, where d is a number of slots for the SCS of the active DL BWP of the first serving cell (e.g., defined in a table), K_{cell,offset} is the cellSpecificKoffset if provided for the second serving cell or 0 otherwise, μ is the SCS configuration of the active DL BWP of the first serving cell, and for a cell that is provided with higher-layer ephemeris parameters the starting time of a slot is the starting time of the slot at the UTSRP of the cell.

The techniques for delaying activation or deactivation of a current cell DRX and/or cell DTX operation by one or more timing offsets as described herein may provide any of various beneficial effects and/or advantages. The technical effects of delaying activation or deactivation of a current cell DRX and/or cell DTX operation may include energy savings for the network increasing based on employing cell DTX and/or cell DRX while also increasing a probability that communications between a network entity (e.g., employing the cell DTX and/or cell DRX) and one or more UEs are successfully communicated, thereby increasing reliability of the communications. For example, uplink transmissions from the UEs to the network entity that would have otherwise been unsuccessfully received at the network entity because the network entity activates cell DRX while the uplink transmissions are in flight to the network entity may have an increased probability of being successfully received at the network entity based on the network entity delaying activation of the cell DRX (e.g., using different timing offsets as described herein). Additional and/or alternative benefits tied to the various aspects for delaying activation or deactivation of a current cell DRX and/or cell DTX operation are further described herein.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

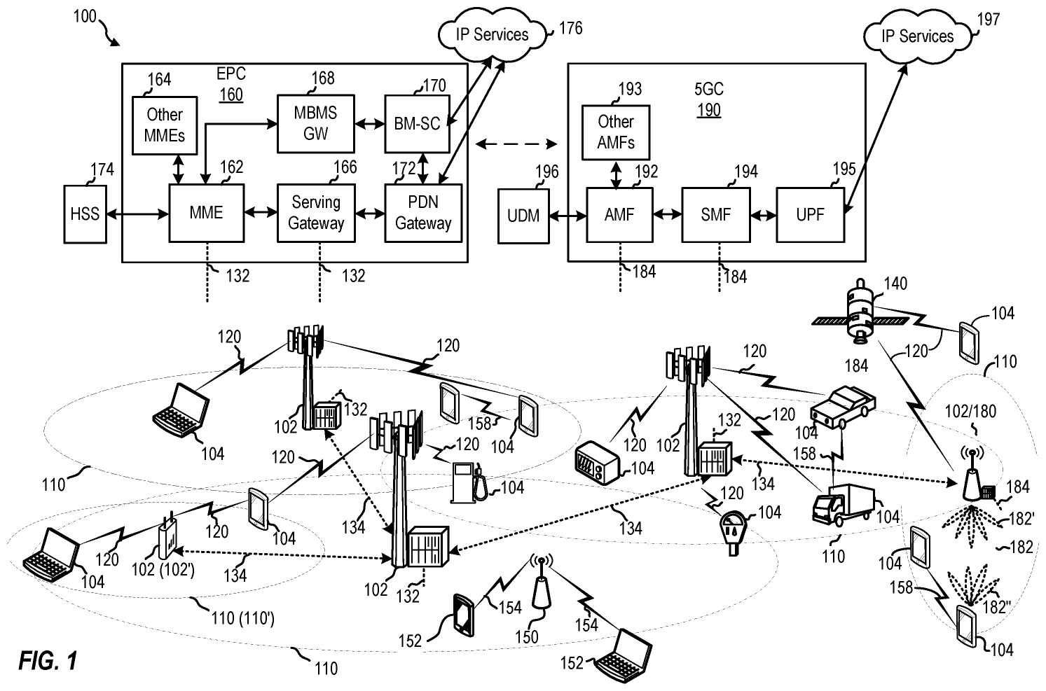

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a UE, a BS, a component of a BS, a server, etc.). As such communications devices are part of wireless communications network 100 and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as NTN entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include UL (also referred to as reverse link) transmissions from a UE 104 to a BS 102 and/or DL (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., BWPs) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

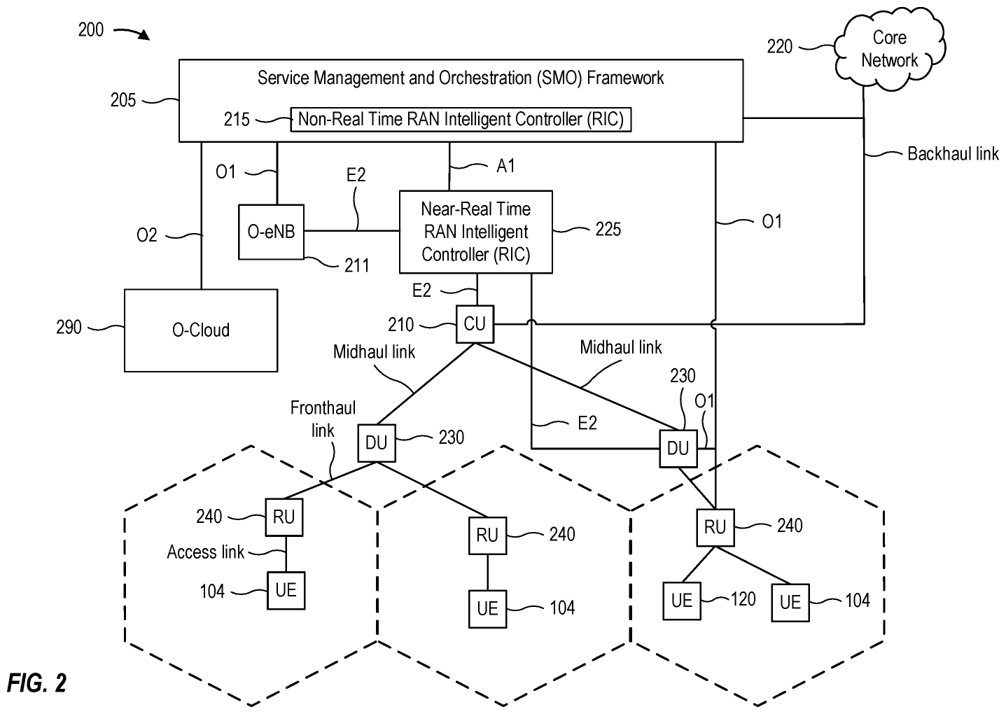

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., a beamforming 182) with a UE (e.g., a UE 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using a device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-CNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

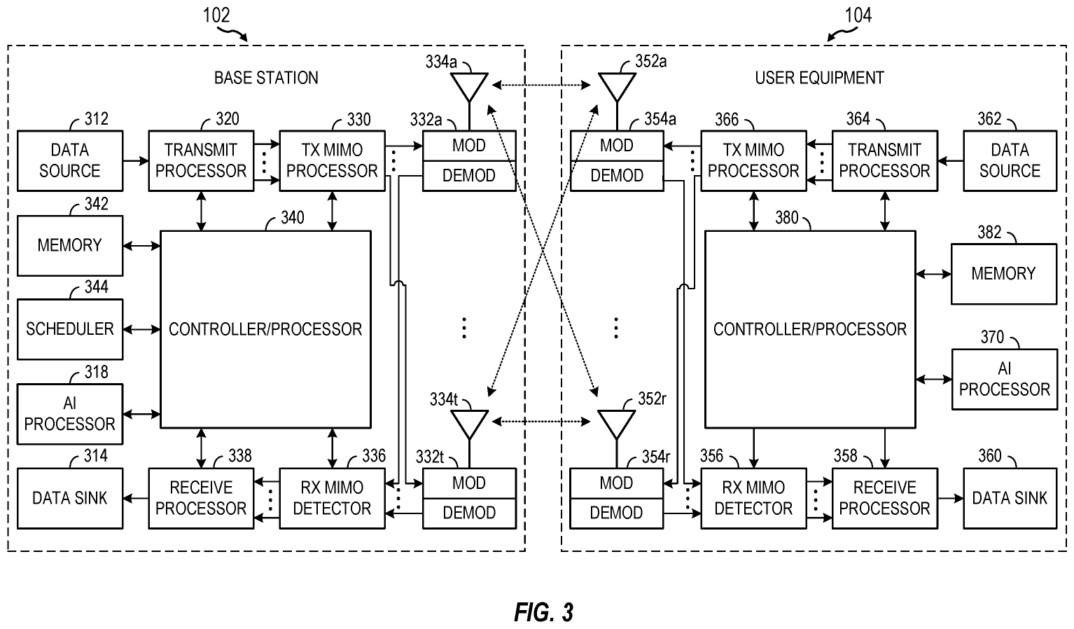

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

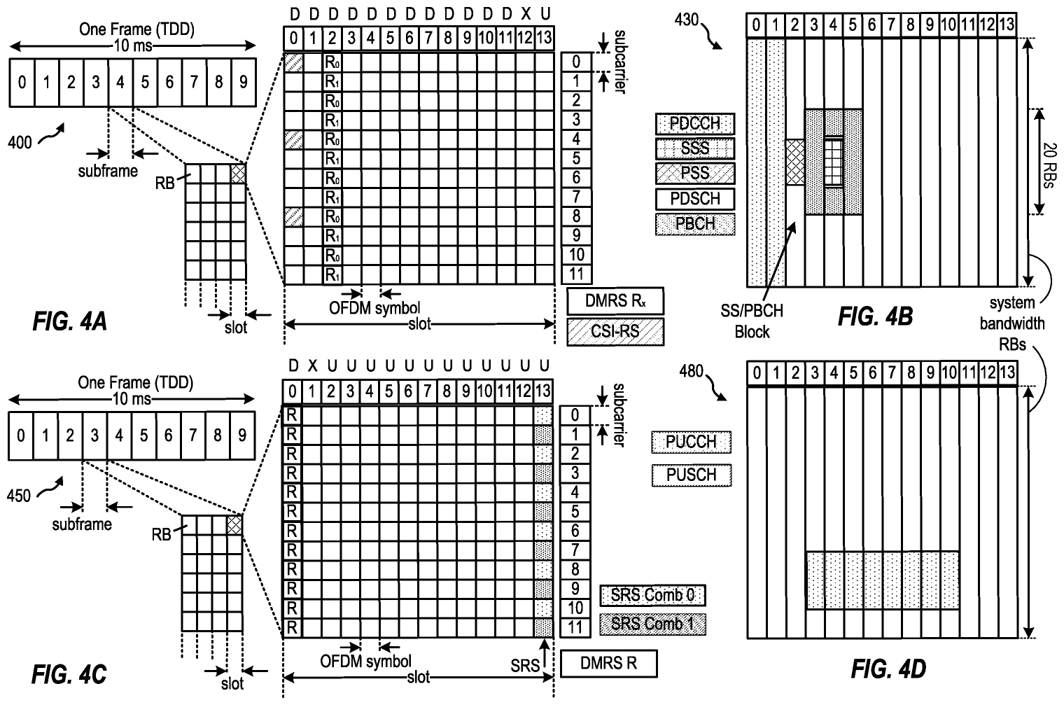

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain SCS and symbol duration as further described herein. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The SCS and symbol length/duration are a function of the numerology. The SCS may be equal to 2^{μ}×15 kHz, where μ is the numerology 0 to 6. As an example, the numerology μ=0 corresponds to an SCS of 15 kHz, and the numerology μ=6 corresponds to an SCS of 960 kHz. The symbol length/duration is inversely related to the SCS. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the SCS is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The PBCH, which carries a master information block (MIB), may be logically grouped with the PSS and SSS to form a synchronization signal (SS)/PBCH block. The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Non-Terrestrial Network Communications

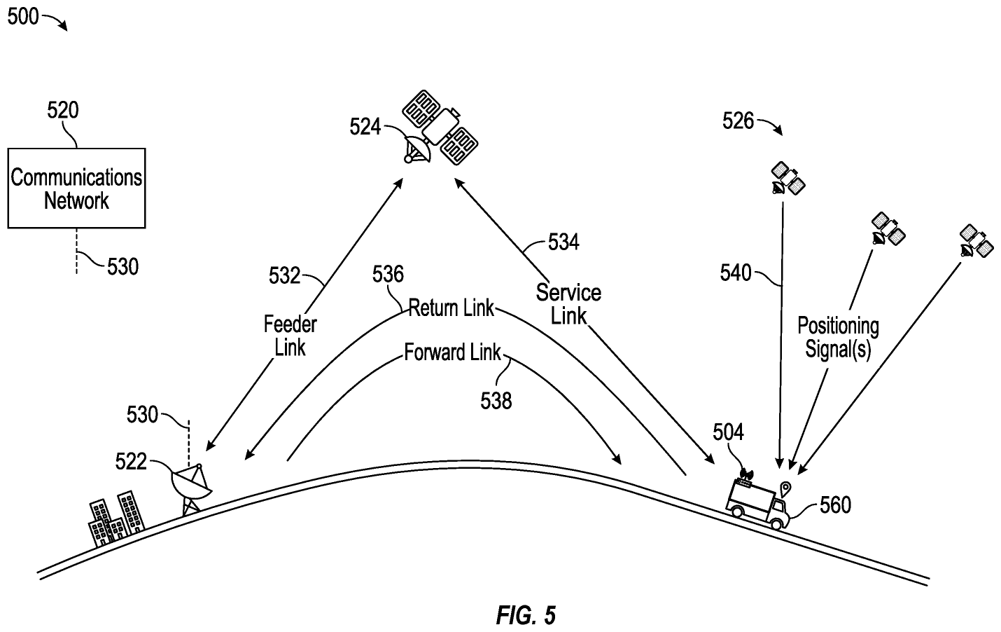

FIG. 5 depicts an example NTN 500. Certain wireless communication systems (e.g., Evolved Universal Terrestrial Radio Access (E-UTRA) systems, 5G New Radio (NR) systems, and/or future wireless communication systems) may facilitate communications coverage via an NTN, such as a spaceborne (e.g., satellite) or airborne (e.g., airship, balloon, etc.) platform that provides wireless connectivity to certain devices, such as UEs. In some cases, NTN communications may further facilitate communications with Narrowband Internet of Things (NB-IoT) devices, such as a sensor and/or identification tag attached to a vehicle (e.g., a delivery truck).

In this example, the NTN 500 includes a communications network 520 (e.g., the EPC 160 and/or the 5GC network 190 of FIG. 1), an NTN gateway 522, and an NTN payload 524. The NTN 500 may facilitate wireless communications with one or more UEs 504 (e.g., the UE 104 of FIG. 1). The UE 504 may include any of various types of UEs, such as an NB-IoT UE. As an example, the UE 504 may include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that the NB-IoT UE is an example, and other UEs may be capable of NTN communications.

The NTN gateway 522 may communicate with the communications network 520 via one or more interfaces 530, such as backhaul links including NG interface(s) and/or S1 interface(s) between a RAN and a core network. The interface(s) 530 may include wired and/or wireless connections. The NTN gateway 522 may serve one or more NTN payloads 524 (e.g., network entities or NTN entities).

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous orbits (GSO), Non-Geosynchronous Orbit (NGSO), which includes Low-Earth Orbit (LEO) and Medium Earth Orbit (MEO), or High Altitude Platform Systems (HAPS).

The NTN payload 524 may transparently forward communications (e.g., the radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link).

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain the location of the NTN payload 524 via system information from the NTN payload 524. The UE 504 may estimate a timing delay and Doppler effects associated with the service link 534 using the positioning signal(s) 540 and the location of the NTN payload 524.

Technical problems for NTN communications include, for example, the long duration of time for communications to travel between a UE and an NTN impacting the implementation of cell DRX and/or cell DTX operations. For example, as described herein, the RTT for NTN communications can be a relatively long duration (e.g., tens of milliseconds, 500 milliseconds for a GEO, etc.) for wireless communications.

### Aspects Related to Activating and Deactivating Cell DRX and Cell DTX

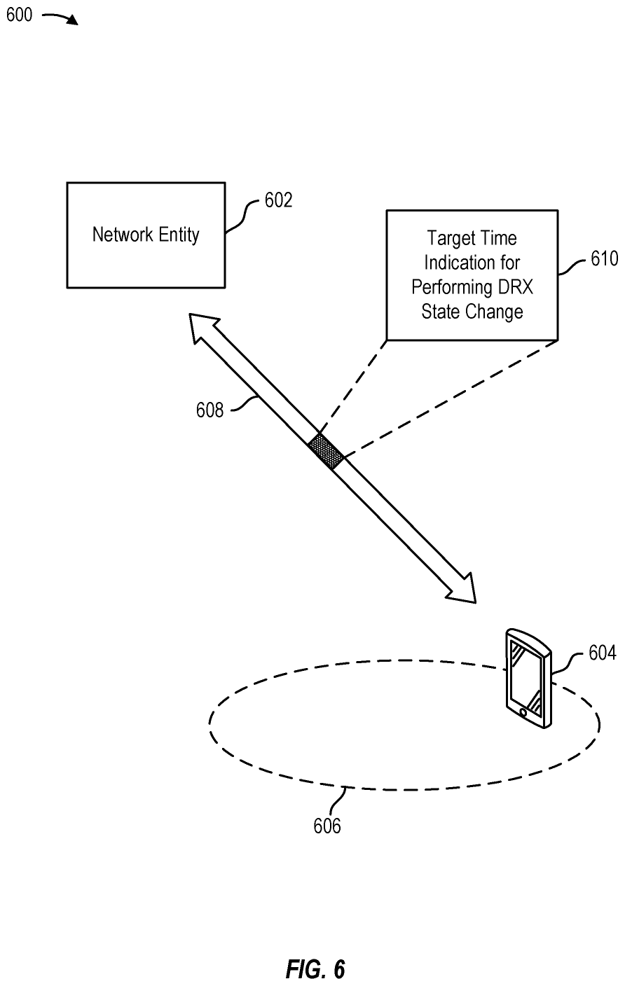

FIG. 6 depicts an example wireless communications network 600 that supports activating and deactivating cell DRX and cell DTX operations in accordance with aspects of the present disclosure. In some examples, the wireless communications network 600 may implement aspects of or may be implemented by aspects of FIGS. 1-5. For example, the wireless communications network 600 may include a network entity 602 and at least one UE 604 (e.g., also called a device), where the network entity 602 represents a base station or similar network entity as described with reference to FIGS. 1-3 and 5 (e.g., BS 102, BS 180, satellite 140, NTN payload 524, etc.) and the UE 604 represents a UE or similar terminal device as described with reference to FIGS. 1-3 and 5 (e.g., UE 104, UE 504, etc.). Additionally, the wireless communications network 600 may support communication between the network entity 602 and the UE 604. For example, the network entity 602 may provide communications coverage for a cell 606 (e.g., a coverage area 110 or a cell as described with reference to FIG. 1) that includes the UE 604, and the network entity 602 and the UE 604 may wirelessly communicate via a communication link 608 (e.g., one or more carriers, a communication link 120, beamforming 182, etc.). While only one (1) UE 604 is depicted in the example of FIG. 6, the network entity 602 may communicate with multiple UEs (e.g., in the cell 606).

In some examples, the network entity 602 may employ cell DTX and cell DRX (e.g., intended to improve energy efficiency of the wireless communications network 600, for example, as part of Network Energy Savings (NES)). For example, the network entity 602 may be a spaceborne platform (e.g., satellite) or an airborne platform (e.g., airship, balloon, etc.) that is constrained by a limited power supply (e.g., solar power, on-board energy storage devices, and/or on-board power generation devices, such as power cells, nuclear reactors, etc.), and energy efficiency is important. Additionally or alternatively, the network entity 602 may be a base station located on the ground that employs cell DTX and cell DRX to improve energy efficiency of the wireless communications network 600.

In cell DTX and cell DRX, the network entity 602 may periodically alternate between an active mode (e.g., “ON” or active periods) and an inactive mode (e.g., “OFF,” inactive, or idle periods). During the active mode, the network entity 602 may power on at least a portion of its internal circuitry to monitor for messages or incoming data (e.g., in cell DRX), such as from the UE 604, or may send messages or outgoing data (e.g., in cell DTX), such as to the UE 604. Additionally or alternatively, in the inactive mode, the network entity 602 may power down at least a portion of its internal circuitry to reduce power consumption, and the network entity 602 is not expected to receive or send messages or data during the inactive mode.

In some examples, the network entity 602 (e.g., or another network entity) may configure parameters for the cell DRX and cell DTX and may signal the parameters to the UE 604 (e.g., and any other UEs served in the cell 606). For example, the network entity 602 may configure timing information (e.g., durations of the active modes and the inactive modes, inactivity timers, retransmission timers, periodicity, etc.) and/or other configuration information for the cell DRX and cell DTX and then may indicate the configuration information to the UE 604 via semi-static signaling (e.g., RRC signaling) or dynamic signaling (e.g., DCI, MAC-CEs, etc.).

Additionally or alternatively, the network entity 602 may activate and/or deactivate the cell DRX or cell DTX (e.g., indicate a change in activation or deactivation of a cell DRX or cell DTX operation) based on transmitting a message to the UE 604 (e.g., via a DCI message, a MAC-CE message, etc.). Typically, after transmitting or receiving the message that activates and/or deactivates the cell DRX or cell DTX operations, the network entity 602 may then accordingly perform the change in activation or deactivation for the cell DRX or cell DTX after a preconfigured delay (e.g., defined by 3GPP, indicated by the network entity 602, etc.). Additionally, the UE 604 may apply the change to activate or deactivate the cell DRX or cell DTX for the network entity 602 based on the preconfigured delay. In some cases, while described as a “preconfigured” delay herein, the delay may generally be referred to as a configured delay that may be a preconfigured value (e.g., defined by 3GPP) or a dynamically configured value (e.g., indicated by the network entity 602).

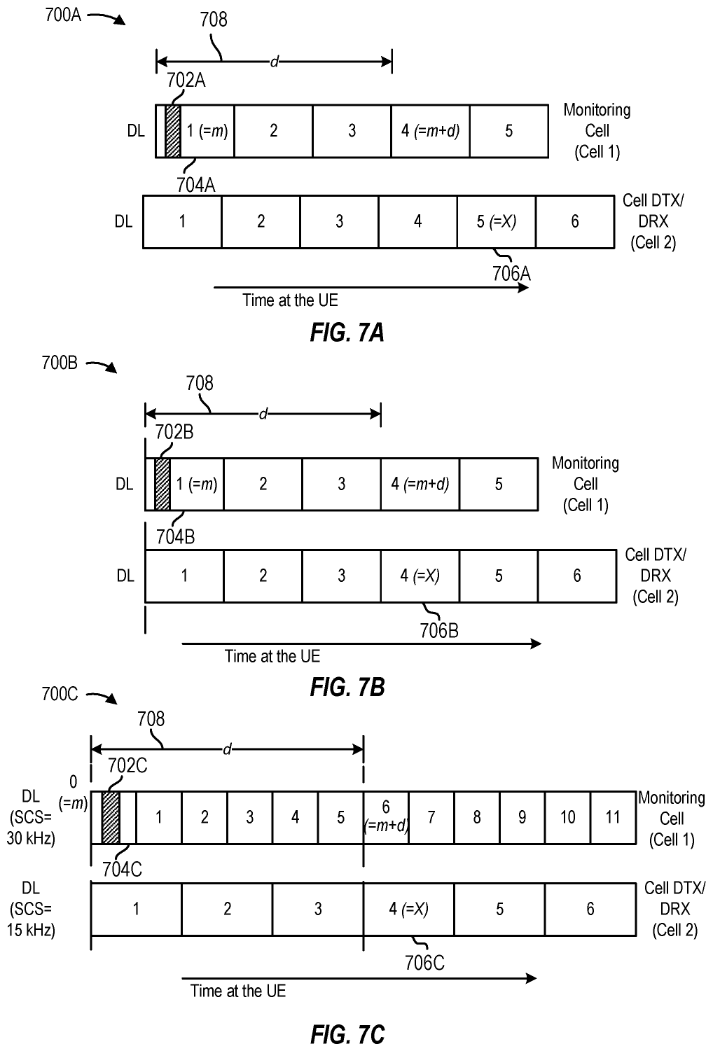

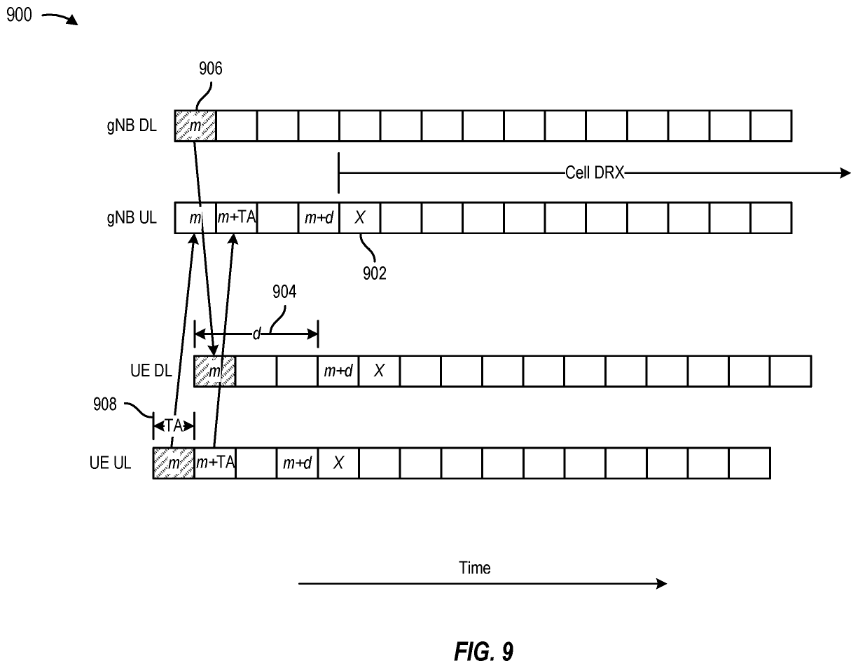

The preconfigured delay is intended to ensure that the network entity 602 and the UE 604 (e.g., and any other UEs communicating with the network entity 602) are synchronized for performing or applying the change in activation or deactivation of the cell DRX or cell DTX or determining the change in activation or deactivation of the cell DRX or cell DTX has occurred at the network entity 602 at a same or approximately same time. The preconfigured delay is illustrated and described in greater detail with reference to FIGS. 7 and 9.

In some embodiments, the preconfigured delay is an integer number of slots, where the integer number depends on an SCS of communications for the network entity 602. For example, when a UE (e.g., the UE 604) receives in slot m on an active DL BWP of a first serving cell (e.g., the cell 606) a PDCCH providing a DCI format 2_9 (e.g., or MAC-CE) that indicates a change in activation or deactivation of a current cell DTX operation or cell DRX operation for a second serving cell, the UE operates on the second serving cell according to the indicated cell DTX operation or cell DRX operation starting from a slot (e.g., a first slot) on the active DL BWP or on an active UL BWP of the second serving cell, respectively, that is not before the beginning of the slot m+d on the active DL BWP of the first serving cell, where d is a number of slots for the SCS of the active DL BWP of the first serving cell as defined below in Table 1. In some examples, the first serving cell may be the same as the second serving cell. For example, the first serving cell and the second serving cell may be the cell 606. Additionally, the preconfigured delay described previously may correspond to d.

TABLE 1
Minimum time gap value d

| SCS (kHz) | Number of slots |
|---|---|
| 15 | 3 |
| 30 | 6 |
| 60 | 12 |
| 120 | 24 |
| 480 | 96 |
| 960 | 192 |

That is, for example, the preconfigured delay (e.g., the minimum time gap value d) may include a number of slots (e.g., as defined in Table 1) between a downlink slot (e.g., slot m) in which an indication that a change in activation or deactivation of a current cell DTX operation or cell DRX operation for a cell (e.g., the cell 606) is received and a subsequent slot (e.g., slot m+d) in which the change in activation or deactivation of the current cell DTX operation or cell DRX operation is performed, is intended to be performed, and/or is applied. As will be used and described herein, the downlink slot in which the indication that the change in activation or deactivation of the current cell DTX operation or cell DRX operation (e.g., for the cell 606) is received may be referred to as an indication transmission slot.

In some embodiments, the indication transmission slot may be a slot that is a downlink slot containing a downlink resource (e.g., PDCCH resource) for DCI in format 2_9 (e.g., received via the cell 606), and the DCI format 2_9 may include the indication that a cell (e.g., first cell, first serving cell, second serving cell, etc.) is preparing to perform the change in activation or deactivation of a current cell DRX and/or cell DTX operation. Additionally or alternatively, the indication transmission slot may be a slot that is a downlink slot containing a downlink resource (e.g., PDSCH resource) for a MAC-CE that includes the indication that a cell is preparing to perform the change in activation or deactivation of a current cell DRX and/or cell DTX operation. If the indication that the cell is preparing to perform the change in activation or deactivation of a current cell DRX and/or cell DTX operation is included in the MAC-CE, UEs that receive the MAC-CE may send an acknowledgment message (e.g., a HARQ acknowledgment (ACK) message) to the network entity 602 (e.g., to confirm reception of the MAC-CE).

In some embodiments, the indication that a first cell is preparing to perform the change in activation or deactivation of a current cell DRX and/or cell DTX operation (e.g., in the DCI format 2_9 or the MAC-CE) may be transmitted via the first cell (e.g., the cell 606). Additionally or alternatively, the indication that the first cell is preparing to perform the change in activation or deactivation of a current cell DRX and/or cell DTX operation may be transmitted via a second cell. In some embodiments, the first cell and the second cell may be served by a same network entity (e.g., a base station). Additionally or alternatively, the first cell and the second cell may be served by different network entities.

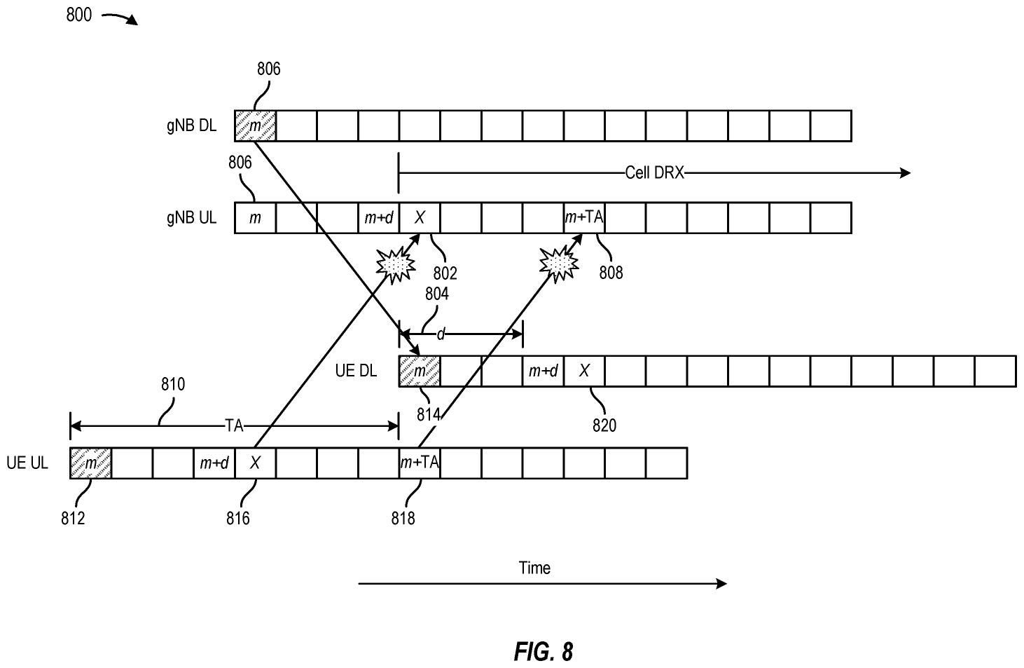

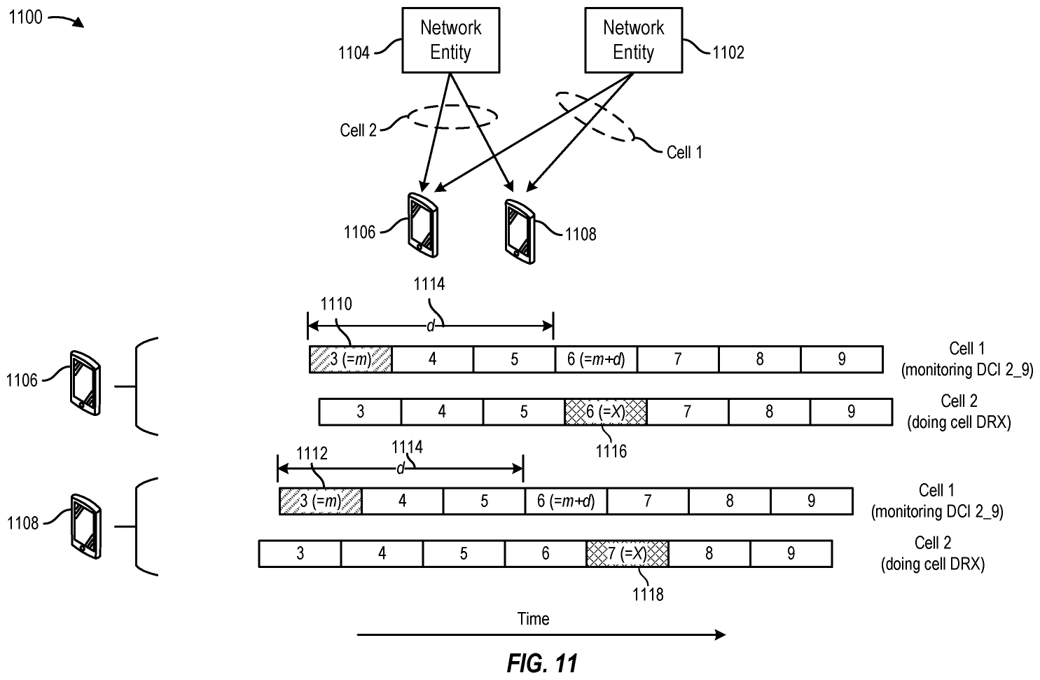

In some cases (e.g., for NES), the signaling for cell DTX/DRX activation/deactivation (e.g., a change in activation or deactivation of a current cell DTX operation or cell DRX operation) may fail to account for certain timing characteristics in the wireless communications network 600. For example, if the wireless communications system 600 is an NTN (e.g., as described with reference to FIG. 5, where the network entity 602 represents a base station that is part of a spaceborne or airborne platform, such as a satellite), the communications between the network entity 602 and the UE 604 may experience a large RTT (e.g., based on the network entity 602 and the UE 604 being located far from each other), and the preconfigured delay is insufficient to account for the large RTT. Additionally or alternatively, in an NTN, a DL time offset between two cells that originate from different satellites may be different among multiple UEs served by the respective cells, and the different DL time offsets are unknown to the network, thereby impacting when each of the multiple UEs apply the change in activation or deactivation of a current cell DTX operation or cell DRX operation. These issues are illustrated and described in greater detail with reference to FIGS. 8 and 11. Additionally, while discussed with respect to an NTN, these issues may exist for a TN or another type of network, where the network entity 602 is a base station on the ground but is located far from the UE 604 and/or the DL time offset is between two cells that originate from different base stations on the ground or from a base station on the ground and a satellite.

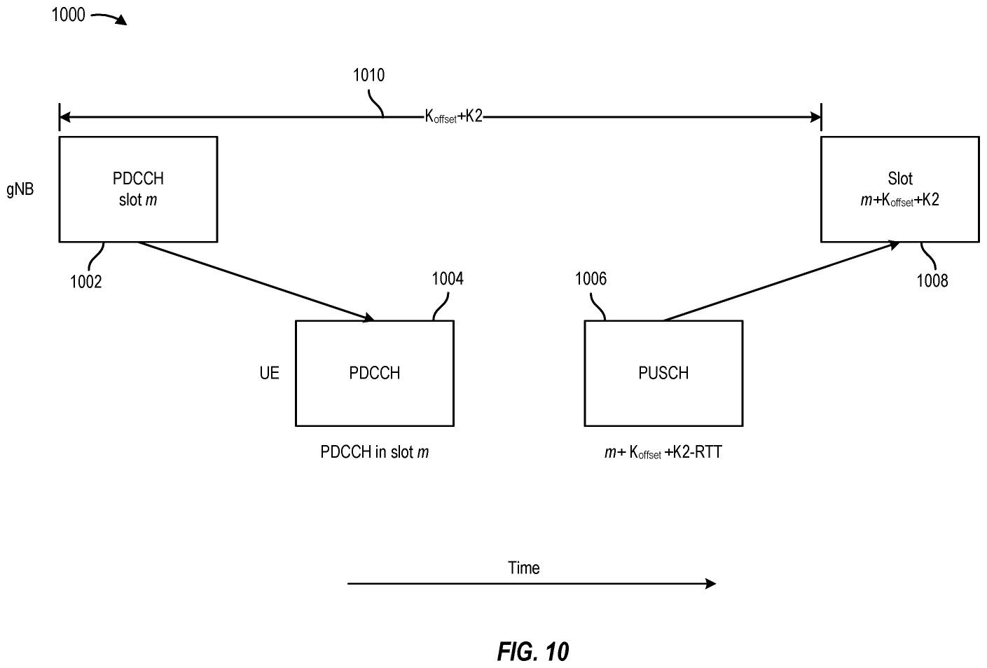

As described herein, enhancements to cell DTX/DRX activation/deactivation signaling are provided (e.g., for NTN and other types of networks) to preempt or mitigate these described issues. For example, when performing a change in activation or deactivation of a current cell DRX and/or cell DTX operation at a first cell (e.g., the cell 606), the network entity 602 may determine a target time for performing the change, where the target time is determined based on a scheduling time offset associated with the first cell (e.g., a cell-specific timing offset that is specific to the first cell, such as the cell 606), an indication transmission slot (e.g., slot in which a message, such as the DCI format 2_9, indicating the change to be performed is received at one or more UEs served by the first cell), and a preconfigured delay (e.g., d as described previously). The scheduling time offset associated with the first cell is illustrated and described in greater detail with reference to FIG. 10.

In some embodiments, the scheduling time offset associated with the first cell may delay the change in activation or deactivation of the current cell DRX and/or cell DTX operation at the first cell to account for the certain timing characteristics in the wireless communications network 600, such as supporting communications that have large RTTs. Additionally or alternatively, the determined target time may mitigate the issue of a DL time offset between two cells that originate from different base stations being different among multiple UEs based on, for example, the determined target time being consistent across the multiple UEs.

In some embodiments, after determining the target time to perform the change in activation or deactivation of a current cell DRX and/or cell DTX operation at the first cell, the network entity 602 may send an indication 610 of the target time for performing the change (e.g., via the cell 606 and the communication link 608). The network entity 602 may send the indication 610 to one or more UEs (e.g., the UE 604) served in the indication transmission slot by the first cell (e.g., the cell 606). For example, the network entity 602 may send the indication 610 to UEs that receive or are intended to receive the message indicating the change is to be performed by the first cell.

The target time may be a beginning of a target slot. In some embodiments, the target slot may be a first slot that is not earlier than the indication transmission slot plus the preconfigured delay plus the scheduling time offset associated with the first cell. For example, the network entity 602 may delay the change in activation or deactivation of a current cell DRX operation and/or cell DTX operation by a timing advance (TA) for the UE 604. Additionally, the network entity 602 may delay the change for all UEs served by the first cell so that all UEs align their expectations of a time for the change in activation or deactivation of the current cell DRX operation and/or cell DTX operation. The delay can be fulfilled by applying the scheduling time offset associated with the first cell (e.g., a cell-specific parameter, K_{offset}).

Applying the scheduling time offset associated with the first cell may be used as a timing enhancement for DCI-based signaling for cell DRX activation or deactivation For example, as described previously, the network entity 602 may indicate (e.g., in the first cell or a different cell) the change (e.g., activation/deactivation) of cell DRX and/or cell DTX for the first cell in DCI (e.g., DCI 2_9) to the UE 604. Accordingly, the UE 604 may be expected to apply cell DRX or cell DTX activation/deactivation change at the beginning of a slot X (e.g., the slot X may be referred to as the target slot herein), where the SCS of the slot X is determined with respect to the active DL or UL BWP of the serving cell that performs the cell DRX or cell DTX, respectively.

Slot X (e.g., the target slot) may be the first slot whose beginning is no earlier than (e.g., same or after) the beginning of slot m+d+K_{offset} (e.g., the cell-specific scheduling time offset associated with the first cell), where d is the preconfigured delay (e.g., which may translate to approximately 3 ms in some examples based on the respective integer number of slots for each SCS defined in Table 1) and m is the indication transmission slot (e.g., DL slot of the monitoring cell) containing the PDCCH of DCI format 2_9 based on the SCS of the PDCCH. The scheduling time offset associated with the first cell (e.g., cell-specific K_{offset}) is a cell-specific scheduling time offset (e.g., rather than UE-specific) and may be signaled in a SIB (e.g., by the network entity 602 via the communication link 608). In some cases, the cell-specific scheduling time offset may be used in initial access.

That is, when a UE (e.g., UE 604) receives in slot m (e.g., the indication transmission slot) on the active DL BWP of a first serving cell (e.g., the cell 606) a PDCCH providing DCI format 2_9 that indicates a change in activation or deactivation of a current cell DTX operation or cell DRX operation for a second serving cell, the UE may operate on the second serving cell according to the indicated cell DTX operation or cell DRX operation starting from the first slot (e.g., the target slot) on the active DL BWP or on the active UL BWP of the second serving cell, respectively, that is not before the beginning of the slot m+d on the active DL BWP of the first serving cell for cell DTX and that is not before the beginning of the slot m+d+K_{cell,offset}×2^{μ} on the active DL BWP of the first serving cell for cell DRX, respectively, where d is a number of slots for the SCS of the active DL BWP of the first serving cell as defined in Table 1, K_{cell,offset} is provided by cellSpecificKoffset from the higher layer (e.g., the cell-specific K_{offset}), and μ is the SCS index of the first serving cell, where μ=0 for SCS of 15 kHz and μ=1 for SCS of 30 kHz and so on. In some embodiments, the first serving cell can be the same as the second serving cell.

In some embodiments, the network entity 602 may send (e.g., in a SIB) an absolute time for when the change in activation or deactivation of a current cell DRX and/or cell DTX operation is to be performed by the current cell and/or to be applied by UEs served by the current cell (e.g., the cell 606). Subsequently, after receiving the DCI 2_9 (e.g., the message containing the indication that the first cell is preparing to perform the change in activation or deactivation of a current cell DRX and/or cell DTX operation), UEs served by the first cell (e.g., including the UE 604) may assume that the change in activation or deactivation of the current cell DRX and/or cell DTX operation is applied or performed at the indicated absolute time. Signaling the absolute time for the change may include a combination of SIB- and DCI-based signaling for cell DRX or cell DTX activation or deactivation, where the absolute time for the change is signaled via a SIB and the indication of the change is signaled via DCI. In some embodiments, the absolute time may be indicated in terms of a combination of SFN, subframe number, slot number, and symbol index, where the combination represents a time at which cell DRX or cell DTX for a cell is expected to be activated or deactivated.

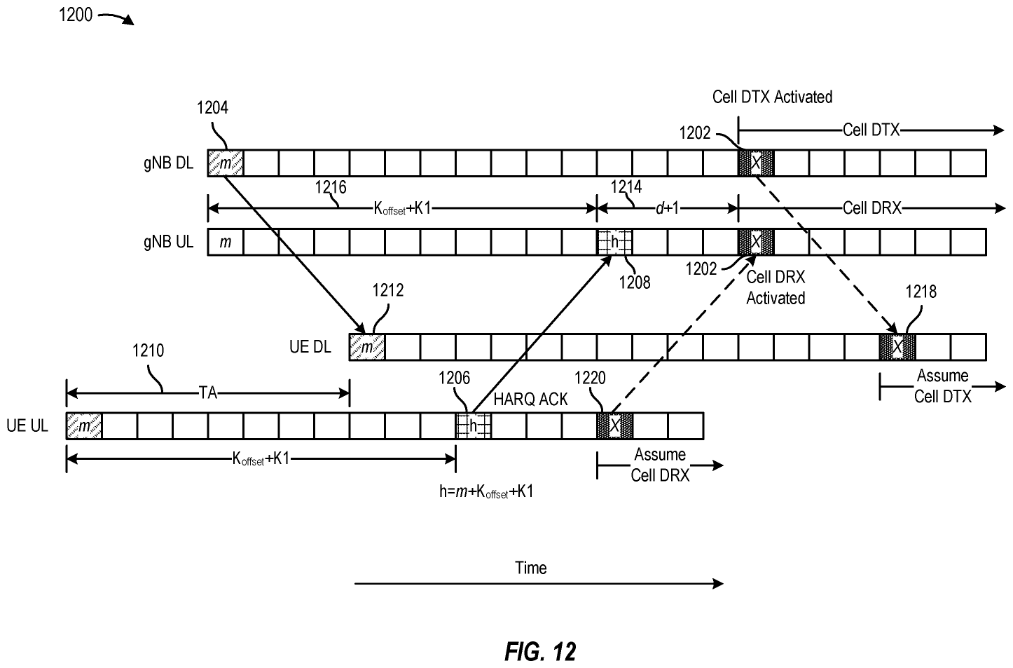

Additionally or alternatively, the target slot may be a first slot that is not earlier than the indication transmission slot plus the preconfigured delay plus the scheduling time offset associated with the first cell plus an acknowledgement feedback offset. For example, if the indication transmission slot includes a MAC-CE that indicates the first cell is preparing to perform the change in activation or deactivation of a current cell DRX and/or cell DTX operation, UEs served by the first cell (e.g., the cell 606) may use a cell-specific offset for a HARQ ACK transmission in response to the reception of the MAC-CE. The acknowledgment feedback offset is illustrated and described in greater detail with reference to FIG. 12.

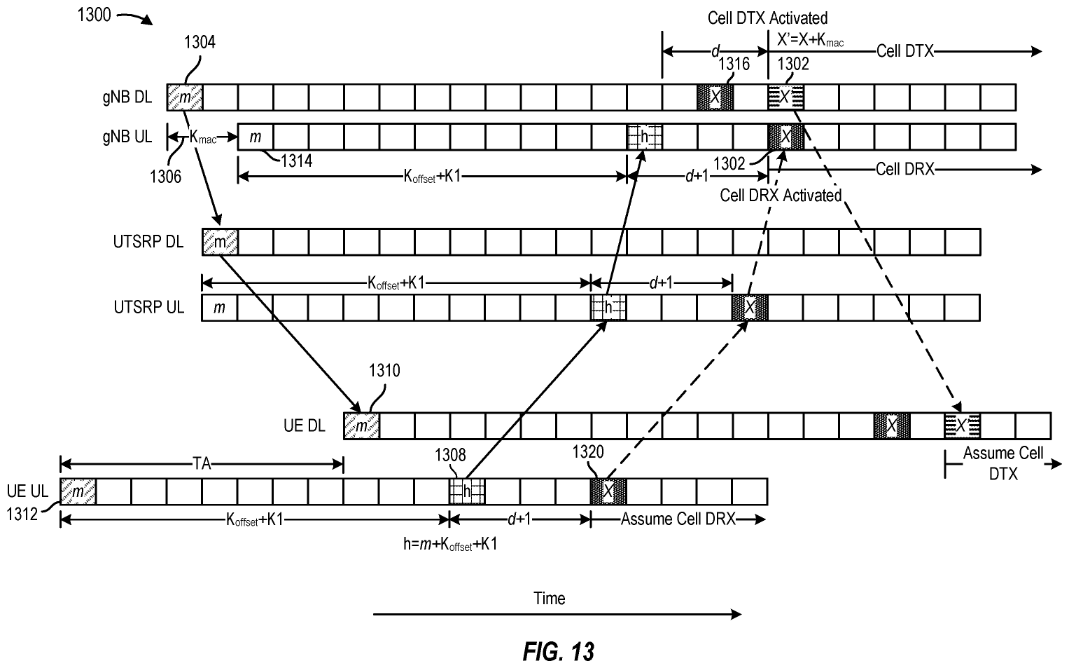

Additionally, in some embodiments, the network entity 602 may further delay the change in activation or deactivation of the current cell DRX and/or cell DTX operation by an additional offset corresponding to an offset between alignment of a downlink frame and an uplink frame at the network entity 602 (e.g., a downlink and uplink frame alignment offset, which may be denoted herein as K_{mac}). For example, the cell DTX activation or deactivation time may be further delayed by the additional offset (e.g., K_{mac}) to occur at a DL time slot X′ (e.g., X′=X+K_{mac}, where X represents a first slot that is not earlier than the indication transmission slot plus the preconfigured delay plus the scheduling time offset associated with the first cell plus an acknowledgement feedback offset). The downlink and uplink frame alignment offset is illustrated and described in greater detail with reference to FIG. 13.

In some embodiments, for a combination of SIB- and MAC-CE-based signaling for cell DTX/DRX activation/deactivation, the network entity 602 may indicate (e.g., in a SIB) an absolute time (e.g., in terms of a combination of SFN, subframe number, slot number, and symbol index) at which cell DTX or cell DRX for a cell is expected to be activated or deactivated. The SIB carrying the absolute time may be sent via a same cell from which the MAC-CE is sent. Accordingly, the network entity 602 may indicate (e.g., in the cell or a different cell) the activation/deactivation of cell DTX/DRX for the cell in a MAC-CE (e.g., in the indication transmission slot), and after receiving the MAC-CE, the UE 604 (e.g., and any other UEs served in the cell) may assume that the cell DTX/DRX for the cell is activated/deactivated at the indicated absolute time.

For example, the difference between the absolute time and the beginning of the time slot when the MAC-CE is transmitted (e.g., the indication transmission slot) is based on a scheduling time offset associated with the first cell (e.g., cell-specific K_{offset}) and a time interval (e.g., K_{mac}) representing the DL and UL time offset at the network entity 602. In some embodiments, the difference may be equal to or greater than K_{offset}+K1+d+K_{mac}+1 slots, where K1 represents a PDSCH (e.g., which carries the MAC-CE) to HARQ ACK delay. Additionally or alternatively, the difference may consider the delay incurred in MAC-CE retransmissions. For example, the difference may be equal to or greater than

$$R \times ( {K}_{offset} + K 1 + d + {K}_{mac} + 1 ) ,$$

where R is the maximum number of retransmissions. As described and used herein, the cell-specific K_{offset} and K_{mac} may refer to the cell where the MAC-CE is sent.

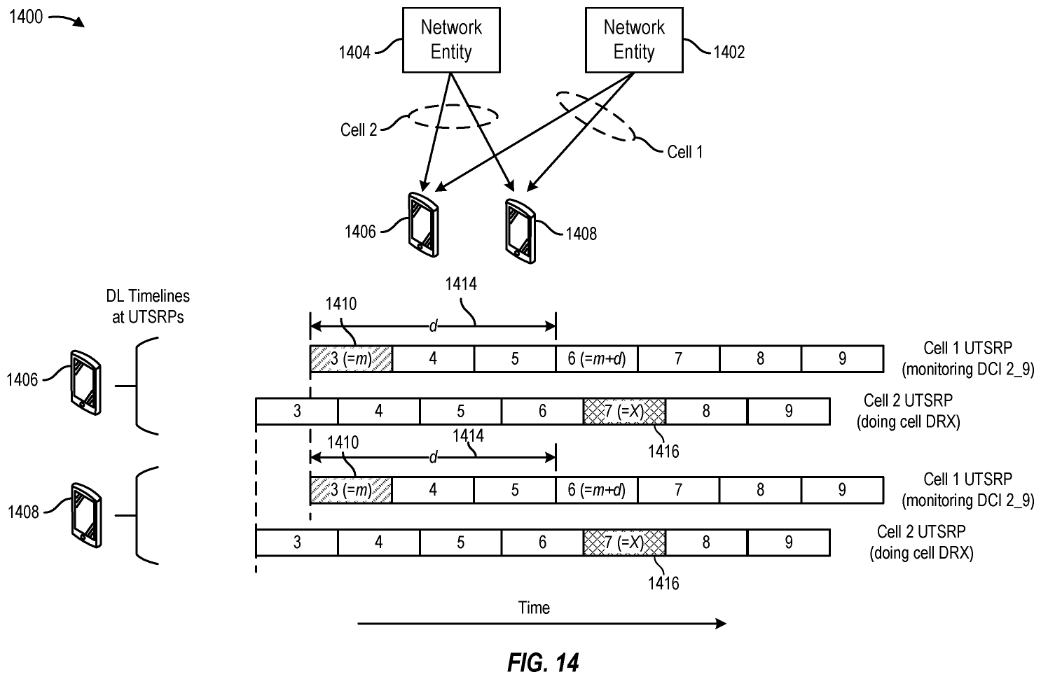

Additionally or alternatively, for a UTSRP-based DCI signaling for cell DTX and/or cell DRX activation or deactivation, after a UE receives a command (e.g., DCI format 2_9) on a first cell to activate or deactivate cell DTX and/or cell DRX on a second cell in a first slot (e.g., slot m), the UE may apply the cell DTX and/or cell DRX activation or deactivation change at the beginning of a subsequent slot (e.g., slot X), where the SCS of the slot X is with respect to the active DL or UL BWP of the second cell, and the slot X refers to a timeline at a UTSRP of the second cell. Additionally, the slot X is a first slot whose beginning is no earlier than (e.g., same or after) the beginning of a slot m+d, where d (e.g., which translates to 3 ms in some examples) is the configured delay or preconfigured delay described herein and m is the slot that includes the command based on the SCS associated with the channel (e.g., PDCCH) over which the command is sent, and slot m refers to a timeline at a UTSRP of the first cell. The UTSRP-based DCI signaling for cell DTX and/or cell DRX activation or deactivation is described in greater detail with reference to FIG. 14.

In some embodiments, the DL timelines from multiple cells at a device (e.g., the UE 604) may be interpreted as physical time or logical time. For example, when the DL timelines are interpreted as physical time, the timelines may be the observed timelines at the device. Additionally or alternatively, when the DL timelines are interpreted as logical time, it is assumed that the time offsets among the timelines are zero.

In some embodiments, the techniques described herein and with reference to FIG. 6 may generally include, when a device (e.g., the UE 604) receives in a slot m on an active DL BWP of a first cell (e.g., a first serving cell) a message (e.g., PDCCH providing DCI format 2_9, MAC-CE, etc.) that indicates a change in activation or deactivation of a current cell DRX operation for a second cell (e.g., second serving cell), the device operates on the second cell according to the indicated cell DRX operation starting from a slot on an active UL BWP of the second cell that is not before the beginning of a slot

$$m + d + {K}_{cell , offset} \cdot {2}^{μ}$$

on the active DL BWP of the first cell, where d is a number of slots for the SCS of the active DL BWP of the first cell (e.g., defined in Table 1), K_{cell,offset} is the cellSpecificKoffset if provided for the second cell (e.g., cell-specific K_{offset}) or 0 otherwise, μ is the SCS configuration of the active DL BWP of the first cell, and for a cell that is provided with higher-layer ephemeris parameters the starting time of a slot is the starting time of the slot at the UTSRP of the cell.

For example, in certain aspects, when a UE receives in slot m on the active DL BWP of a first serving cell a PDCCH providing DCI format 2_9 that indicates a change in activation or deactivation of a current cell DTX operation for a second serving cell, the UE may operate on the second serving cell according to the indicated cell DTX operation starting from a slot on the active DL BWP of the second serving cell, that is not before the beginning of the slot m+d on the active DL BWP of the first serving cell where d is a number of slots for the SCS of the active DL BWP of the first serving cell in Table 1. When a UE receives in slot m on the active DL BWP of a first serving cell a PDCCH providing DCI format 2_9 that indicates a change in activation or deactivation of a current cell DRX operation for a second serving cell, the UE may operate on the second serving cell according to the indicated cell DRX operation starting from a slot on the active UL BWP of the second serving cell that is not before the beginning of the slot m+d+K_{cell,offset}·2^{μ} on the active DL BWP of the first serving cell, where d is a number of slots for the SCS of the active DL BWP of the first serving cell in Table 1, K_{cell,offset} is the cellSpecificKoffset if provided for the second serving cell or 0 otherwise, μ is the SCS configuration of the active DL BWP of the first serving cell, and for a cell that is provided with higher-layer ephemeris parameters the starting time of a slot is the starting time of the slot at the UTSRP of the cell.

Additionally or alternatively, the techniques described herein and with reference to FIG. 6 may generally include, when a device (e.g., the UE 604) receives in a slot m on an active DL BWP of a first cell (e.g., a first serving cell) a message (e.g., PDCCH providing DCI format 2_9, MAC-CE, etc.) that indicates a change in activation or deactivation of a current cell DRX operation for a second cell (e.g., second serving cell), the device operates on the second cell according to the indicated cell DRX operation starting from a slot on an active UL BWP of the second cell that is not before the beginning of a slot

m+d+K_{cell,offset}·2^{μ}

on the active DL BWP of the first cell, where d is a number of slots for the SCS of the active DL BWP of the first cell (e.g., defined in Table 1), K_{cell,offset} is the cellSpecificKoffset if provided for the second cell (e.g., cell-specific K_{offset}) or 0 otherwise, and μ is the SCS configuration of the active DL BWP of the first cell. In some embodiments, this determination of when the device operates on the second cell according to the indicated cell DRX operation applies to a logical time interpretation of DL timelines at the device.

For example, in certain aspects, when a UE receives in slot m on the active DL BWP of a first serving cell a PDCCH providing DCI format 2_9 that indicates a change in activation or deactivation of a current cell DTX operation for a second serving cell, the UE may operate on the second serving cell according to the indicated cell DTX operation starting from a slot on the active DL BWP of the second serving cell, that is not before the beginning of the slot m+d on the active DL BWP of the first serving cell where d is a number of slots for the SCS of the active DL BWP of the first serving cell in Table 1. When a UE receives in slot m on the active DL BWP of a first serving cell a PDCCH providing DCI format 2_9 that indicates a change in activation or deactivation of a current cell DRX operation for a second serving cell, the UE may operate on the second serving cell according to the indicated cell DRX operation starting from a slot on the active UL BWP of the second serving cell that is not before the beginning of the slot m+d+K_{cell,offset}. 2″ on the active DL BWP of the first serving cell where d is a number of slots for the SCS of the active DL BWP of the first serving cell in Table 1, K_{cell,offset} is the cellSpecificKoffset if provided for the second serving cell or 0 otherwise, and μ is the SCS configuration of the active DL BWP of the first serving cell. In some embodiments, this determination of when the UE operates on the second cell according to the indicated cell DRX operation applies to a logical time interpretation of DL timelines at the UE.

### Example Timelines for Cell DRX and/or Cell DTX Activation or Deactivation with DCI-Based Signaling

FIG. 7A depicts an example of a timeline 700A for cell DRX or cell DTX activation with DL timelines that are interpreted as physical time in accordance with aspects of the present disclosure. FIG. 7B depicts an example of a timeline 700B for cell DRX or cell DTX activation with DL timelines interpreted as logical time and the DL timelines having a same SCS in accordance with aspects of the present disclosure. FIG. 7C depicts an example of a timeline 700C for cell DRX or cell DTX activation with DL timelines interpreted as logical time and the two DL timelines having different SCSs in accordance with aspects of the present disclosure. In some examples, the timeline 700A, the timeline 700B, and the timeline 700C (e.g., for cell DRX or cell DTX activation) may implement aspects of or may be implemented by aspects of FIGS. 1-6. For example, the timeline 700A, the timeline 700B, and the timeline 700C may represent a UE monitoring for and/or receiving downlink communications from a first cell (e.g., a monitoring cell, Cell 1) and from a second cell (e.g., a cell performing cell DTX/DRX operations, Cell 2), where the UE, the first cell, and the second cell represent examples of corresponding devices or elements as described with reference to FIGS. 1-3 and 5-6.

In the examples of FIGS. 7A, 7B, and 7C, the UE may monitor for a DCI format 2_9 on the first cell for a cell DTX/DRX activation/deactivation for the second cell, as described with reference to FIG. 6. For example, in FIG. 7A, the UE may monitor for and receive a downlink resource 702A (e.g., PDCCH resource) for the DCI format 2_9 in a slot 704A (e.g., slot m or the indication transmission slot as used herein) via the first cell, and the DCI format 2_9 may indicate the second cell is going to perform a change in activation or deactivation of a cell DRX operation or cell DTX operation.

In some cases, the UE is expected to apply the cell DTX or cell DRX activation or deactivation change at the beginning of a slot X (e.g., a slot 706A), where the SCS of slot X is with respect to the active DL or UL BWP of the second cell, respectively. Slot X is a first slot (e.g., the slot 706A) whose beginning is no earlier than (e.g., same or after) a beginning of slot m+d, where m is the slot 704A (e.g., containing the PDCCH of DCI format 2_9 based on the SCS of the PDCCH) and d (e.g., which may translate to approximately 3 ms in some examples) is a delay 708 (e.g., the preconfigured delay as described with reference to FIG. 6 and defined in Table 1). The DCI format 2_9 can be sent in the cell performing the cell DTX or cell DRX activation/deactivation (e.g., not illustrated) or in a different cell (e.g., as illustrated in the example of FIG. 7A). In some cases, a DCI (e.g., DCI format 2_9) can carry the cell DTX or cell DRX activation/deactivation indications for multiple cells. Additionally, there is no HARQ ACK for DCI format 2_9.

As described with reference to FIG. 6, the delay 708 may be an integer number of slots in some examples, where the integer number depends on an SCS of a DL active BWP of the first cell (e.g., the monitoring cell or the cell that transmits the DCI format 2_9) as defined in Table 1. Accordingly, the delay 708 may represent an amount of time (e.g., corresponding to the integer number of slots) between the first cell sending the DCI format 2_9 in the slot 704A and the second cell performing the change in activation or deactivation of the cell DRX operation or cell DTX operation in the slot 706A, and the DL timelines may be interpreted as physical time (e.g., observed timelines at the UE).

In the example of FIG. 7B, the UE may monitor for and receive a downlink resource 702B (e.g., PDCCH resource) for the DCI format 2_9 in a slot 704B (e.g., slot m or the indication transmission slot as used herein) via the first cell, and the DCI format 2_9 may indicate the second cell is going to perform a change in activation or deactivation of a cell DRX operation or cell DTX operation.

In some cases, the UE is expected to apply the cell DTX or cell DRX activation or deactivation change at the beginning of a slot X (e.g., a slot 706B), where the SCS of slot X is with respect to the active DL or UL BWP of the second cell, respectively. Slot X is a first slot (e.g., the slot 706B) whose beginning is no earlier than (e.g., same or after) a beginning of slot m+d, where m is the slot 704B (e.g., containing the PDCCH of DCI format 2_9 based on the SCS of the PDCCH) and d is the delay 708. The DCI format 2_9 can be sent in the cell performing the cell DTX or cell DRX activation/deactivation (e.g., not illustrated) or in a different cell (e.g., as illustrated in the example of FIG. 7B). Additionally, the delay 708 may represent an amount of time (e.g., corresponding to the integer number of slots) between the first cell sending the DCI format 2_9 in the slot 704B and the second cell performing the change in activation or deactivation of the cell DRX operation or cell DTX operation in the slot 706B, and the DL timelines are interpreted as logical time (e.g., the time offsets among the timelines are assumed to be zero).

In the example of FIG. 7C, the UE may monitor for and receive a downlink resource 702C (e.g., PDCCH resource) for the DCI format 2_9 in a slot 704C (e.g., slot m or the indication transmission slot as used herein) via the first cell, and the DCI format 2_9 may indicate the second cell is going to perform a change in activation or deactivation of a cell DRX operation or cell DTX operation. Additionally, in the example of FIG. 7C, the DL timelines for each cell may include different SCSs. For example, the DL timeline for the first cell may include a first SCS (e.g., 30 kHz), and the DL timeline for the second cell may include a second SCS (e.g., 15 kHz).

In some cases, the UE is expected to apply the cell DTX or cell DRX activation or deactivation change at the beginning of a slot X (e.g., a slot 706C), where the SCS of slot X is with respect to the active DL or UL BWP of the second cell, respectively. Slot X is a first slot (e.g., the slot 706C) whose beginning is no earlier than (e.g., same or after) a beginning of slot m+d, where m is the slot 704C (e.g., containing the PDCCH of DCI format 2_9 based on the SCS of the PDCCH) and d is the delay 708. The DCI format 2_9 can be sent in the cell performing the cell DTX or cell DRX activation/deactivation (e.g., not illustrated) or in a different cell (e.g., as illustrated in the example of FIG. 7C). Additionally, the delay 708 may represent an amount of time (e.g., corresponding to the integer number of slots) between the first cell sending the DCI format 2_9 in the slot 704C and the second cell performing the change in activation or deactivation of the cell DRX operation or cell DTX operation in the slot 706C, and the DL timelines are interpreted as logical time (e.g., the time offsets among the timelines are assumed to be zero) and have different SCSs.

FIG. 8 depicts an example of a cell DRX timeline 800 with a large RTT in accordance with aspects of the present disclosure. In some examples, the cell DRX timeline 800 may implement aspects of or may be implemented by aspects of FIGS. 1-7. For example, the cell DRX timeline 800 may represent a timeline of a network entity (e.g., a base station, a gNB, etc.) communicating with a UE with both UL and DL transmissions (e.g., DL transmissions occur from the gNB DL to the UE DL, and UL transmissions occur from the UE UL to the gNB UL), where the network entity and the UE represent examples of corresponding devices as described with reference to FIGS. 1-3 and 5-7.

Additionally, in the example of FIG. 8 and as described with reference to FIGS. 6 and 7, the cell DRX timeline 800 may represent the network entity activating a cell DRX operation (e.g., on the gNB UL) starting at a slot 802 based on a delay 804 (e.g., the preconfigured delay as referenced herein) after sending an indication to the UE in a slot 806 (e.g., a DCI format 2_9 or a MAC-CE indicating the network entity is preparing to activate the cell DRX operation). In the example of FIG. 8, transmission of the indication of the change (e.g., the DCI format 2_9 or MAC-CE) and the cell DRX are performed on the same cell, but examples are not limited thereto (e.g., the transmission and the cell DRX are performed on different cells).

In some cases, the signaling for performing a change in activation or deactivation of a cell DRX operation or cell DTX operation as described with reference to FIG. 7A (e.g., using the preconfigured delay, the delay 708, the delay 804, etc.) may be sufficient for performing a change in activation or deactivation of a cell DTX operation, but problems may arise when attempting to perform a change in activation or deactivation of a cell DRX operations when applying the preconfigured delay alone. For example, the delay 804 (e.g., d as defined in Table 1) may be shorter than an RTT for communications between the network entity and the UE. As an example, the network entity and the UE may be part of an NTN (e.g., as described with reference to FIG. 5), such that the distance between the network entity and the UE is large, resulting in a large propagation delay and large RTT for any transmissions travelling between the network entity and the UE. Additionally or alternatively, the network entity and the UE may be otherwise located far from each other (e.g., in a TN), resulting in a large propagation delay and large RTT.

When a cell (e.g., the network entity) activates cell DRX (e.g., at the slot 802 that is a first slot whose beginning is not earlier than a beginning of the slot 806 plus the delay 804, given by m+d), there could be UL transmissions in flight from the UE to the network entity targeting an UL slot X or later slots at the network entity (e.g., the slot 802 and after), and the UL transmissions will not be received by the network entity (e.g., based on the network entity activating the cell DRX). Specifically, these UL transmissions may include those (potentially many) destined for UL slots at the network entity (e.g., gNB UL slots) from the slot 802 (e.g., slot m+d+1) through a slot 808 (e.g., slot m+TA).

In some cases, a TA 810 may exist for the UE. A TA is used to control uplink transmission timing of an individual UE. TAs help to ensure that uplink transmissions from all UEs served by the network entity are synchronized when received by the network entity (e.g., base station). For example, a first uplink frame number or slot number (e.g., a slot 812) for transmission from a UE shall start before the start of a corresponding downlink frame or slot number at the UE (e.g., a slot 814) according to the TA 810. The TA 810 may be UE-specific and may be determined based on the connection between a respective UE and the network entity (e.g., based on a propagation delay and/or the RTT between the UE and the network entity). In some cases, the UE may make a first assumption for the TA 810 (e.g., during initial access with the network entity), and the network entity may adjust the TA 810 subsequently during communications with the UE.

UEs closer to the network entity may have a shorter propagation delay (e.g., and shorter RTT) and, hence, a smaller TA, whereas UEs further away from the network entity may have a longer propagation delay (e.g., and longer RTT) and, hence, a larger TA. Accordingly, when the UE is located far from the network entity (e.g., as part of an NTN or a TN as described herein), the TA 810 may be long, such that the UE may attempt to send UL transmissions to the network entity before receiving the indication that the network entity is preparing to activate the cell DRX operation in the slot 814. For example, the UE may attempt to send UL transmissions to the network entity in an UL slot that occurs between a slot 816 and a slot 818.

However, based on the long RTT for communications between the network entity and the UE, UL transmissions sent on slots from the slot 816 to the slot 818 may not arrive at the network entity until after the network entity activates the cell DRX operation (e.g., the network entity is in an inactive period), and thus will not be received. UL transmissions sent prior to the slot 816 may arrive at the network entity before the network entity activates the cell DRX operation (e.g., prior to the slot 802) and, thus, may be successfully received at the network entity. Additionally, the UE may receive the indication in the slot 814 (e.g., slot m+TA on the UE UL) that the network entity is preparing to perform the activation of the cell DRX operation, and thus, the UE may refrain from sending UL transmissions to the network entity in slots after the slot 814, where TA is in unit of slots and is assumed to be an integer number of slots in duration in the example.

That is, based on the long RTT (e.g., and long TA 810) for communications between the network entity and the UE, the network entity may perform the activation of the cell DRX operation starting at the slot 802 (e.g., corresponding to the slot 814 at the UE), but the UE may not apply the activation of the cell DRX operation at the network entity until a slot 820 (e.g., corresponding to the slot 808 at the network entity). Subsequently, any UL transmissions sent on UE UL slots from the slot 816 to the slot 818 may be transmitted prior to the network entity activating the cell DRX operation, but the UL transmissions do not arrive at the network entity until or after the slot 802 when the network entity activates the cell DRX operation, thereby causing the UL transmissions to not be successfully received by the network entity.

Accordingly, based on the techniques and signaling described herein and with respect to FIG. 6, the network entity may delay the activation of the cell DRX operation by the TA based on applying a cell-specific scheduling time offset (e.g., a scheduling time offset associated with the network entity, such as K_{offset}). For example, by applying the cell-specific scheduling time offset, the network entity may delay the activation of the cell DRX operation until the slot 808, thereby enabling or increasing a probability that UL transmissions sent by the UE before receiving an indication of the activation (e.g., in slot 814) to be successfully received at the network entity. Additionally, in some embodiments, the network entity may delay the activation of the cell DRX operation for all UEs served by the network entity (e.g., in a corresponding cell) so that all UEs align their expectations of the cell DRX activation time.

FIG. 9 depicts an example of a cell DRX timeline 900 for a TN in accordance with aspects of the present disclosure. In some examples, the cell DRX timeline 900 may implement aspects of or may be implemented by aspects of FIGS. 1-8. For example, the cell DRX timeline 900 may represent a timeline of a network entity (e.g., a base station, a gNB, etc.) communicating with a UE with both UL and DL transmissions (e.g., DL transmissions occur from the gNB DL to the UE DL, and UL transmissions occur from the UE UL to the gNB UL), where the network entity and the UE represent examples of corresponding devices as described with reference to FIGS. 1-3 and 5-8.

In the example of FIG. 9 and as described with reference to FIGS. 6-8, the cell DRX timeline 900 may represent the network entity activating a cell DRX operation (e.g., on the gNB UL) starting at a slot 902 based on a delay 904 (e.g., the preconfigured delay as referenced herein) after sending an indication to the UE in a slot 906 (e.g., a DCI format 2_9 or a MAC-CE indicating the network entity is preparing to activate the cell DRX operation). In the example of FIG. 9, transmission of the indication of the change (e.g., the DCI format 2_9 or MAC-CE) and the cell DRX are performed on the same cell, but examples are not limited thereto (e.g., the transmission and the cell DRX are performed on different cells).

Additionally, in the example of FIG. 9, the network entity and the UE may be part of a TN or similar network where the network entity and the UE are close in location to each other and/or have a short RTT for the communications. For a TN or similar network with a short RTT, a TA 908 for the UE may be smaller than the delay 904. Accordingly, the issue described with respect to FIG. 8 may not exist where UL transmissions do not arrive at the network entity after the network entity activates the cell DRX operation.

For example, based on the short RTT, the UE may receive the indication that the network entity is preparing to activate the cell DRX operation before attempting to send UL transmissions that would otherwise arrive at the network entity after the activation of the cell DRX operation being performed by the network entity based on the delay 904 (e.g., in the slot 902). Accordingly, for networks with short RTTs, the delay 904 may be sufficient for the UE to receive and process the indication that the network entity is preparing to activate the cell DRX operation, finish sending any in-progress UL transmissions to the network entity during the delay 904, and then apply the activation of the cell DRX operation after the delay 904 elapses.

FIG. 10 depicts an example timeline 1000 with a scheduling time offset for NTN communications in accordance with aspects of the present disclosure. In some examples, the timeline 1000 may implement aspects of or may be implemented by aspects of FIGS. 1-9. For example, the timeline 1000 may represent a timeline of a network entity (e.g., a base station, a gNB, etc.) communicating with a UE, where the network entity and the UE represent examples of corresponding devices as described with reference to FIGS. 1-3 and 5-9. In the example of FIG. 10, the network entity may transmit a DCI in a PDCCH to the UE, where the DCI schedules a PUSCH for the UE to transmit to the network entity.

Additionally, the timeline 1000 may include a scheduling time offset associated with the network entity (e.g., cell-specific K_{offset} as described herein) for the communications between the UE and the network entity. For example, the PUSCH transmitted by the UE may be expected to arrive at the network entity according to a timing offset after the DCI is transmitted in the PDCCH, where the timing offset is based in part on the scheduling time offset associated with the network entity.

In some embodiments, K_{offset} is introduced and defined to accommodate communications with large propagation delays (e.g., in NTNs) to ensure causality. K_{offset} is greater than or equal to the RTT (e.g., a largest RTT among a group of UEs) between the UE and the network entity (e.g., or more generally the RTT between the UE and a UTSRP). A UE may use one of two K_{offset} types: a cell-specific K_{offset} (e.g., signaled in a SIB, used in initial access) or a UE-specific K_{offset} (e.g., smaller than the cell-specific offset to lower scheduling delay). For example, the network entity may send the cell-specific K_{offset} (e.g., scheduling time offset associated with a cell) to one or more UEs served by the network entity (e.g., or served by a cell of the network entity), such as in a SIB.

Accordingly, as illustrated in the example of FIG. 10, the network entity may transmit the DCI in the PDCCH in a slot 1002 (e.g., a slot m at the network entity), and the UE may receive the DCI in the PDCCH in a slot 1004 (e.g., a slot m at the UE). The DCI may indicate for the UE to transmit the PUSCH in a slot 1006 (e.g., a slot equal to m+K_{offset}+K2−RTT at the UE), such that the PUSCH is received at the network entity in a slot 1008 (e.g., a slot equal to m+K_{offset}+K2 at the network entity). The difference in the slot 1002 and the slot 1008 at the network entity may be equal to a timing offset 1010, where the timing offset 1010 is equal to K_{offset}+K2. K2 may represent the PDCCH-to-PUSCH delay when the RTT is negligible relative to a time slot (e.g., the delay between the transmission of the PDCCH and the receiving of the PUSCH that is scheduled by the PDCCH).

As used and described herein, K_{offset} may correspond to a TA for the UE (e.g., the TA 810 as described with reference to FIG. 8).

FIG. 11 depicts an example of a cell DRX timeline 1100 for communications with multiple cells in accordance with aspects of the present disclosure. In some examples, the cell DRX timeline 1100 may implement aspects of or may be implemented by aspects of FIGS. 1-10. For example, the cell DRX timeline 1100 may include a first network entity 1102, a second network entity 1104, a first UE 1106, and a second UE 1108, which may represent respective examples of corresponding devices as described with reference to FIGS. 1-3 and 5-10.

In the example of FIG. 11, DCI format 2_9 transmission (e.g., indicating a change in activation or deactivations of a cell DRX operation) and cell DRX occur on different cells that are originated from different network entities (e.g., satellites, base stations, etc.). For example, the first network entity 1102 may transmit the DCI format 2_9 via a first cell (e.g., a cell 1 used by the UEs for monitoring for DCI), and the second network entity 1104 may perform the cell DRX via a second cell (e.g., a cell 2 doing the cell DRX). However, a DL time offset of the two cells may be different among the UEs, and the UEs may identify different values for when the second network entity 1104 activates or deactivates the cell DRX.

For example, as described previously, the UEs may be expected to apply the activation or deactivation of cell DRX for the second network entity 1104 at a slot X that is a first slot whose beginning is not earlier than a beginning of slot m+d, where m is the slot containing the PDCCH of DCI format 2_9 received at the UE (e.g., a slot 1110 for the first UE 1106 and a slot 1112 for the second UE 1108) and d is a delay 1114 (e.g., the preconfigured delay described herein). However, based on the different DL time offsets for the UEs, the first UE 1106 may infer X=7 (e.g., a slot 1116), and the second UE 1108 may infer X=8 (e.g., a slot 1118). Subsequently, the two UEs may apply the activation or deactivation of cell DRX for the second network entity 1104 at different slots, thereby possibly resulting in one or more UL transmissions being unsuccessfully received at the second network entity 1104 (e.g., based on the second UE 1108 applying the activation or deactivation of cell DRX for the second network entity 1104 later in time, possibly after the second network entity 1104 activates the cell DRX) and/or a misalignment of UL transmissions received at the second network entity 1104.

Accordingly, as described with reference to FIG. 6 (e.g., to preempt or mitigate this issue of different DL time offsets), the network may signal an absolute time (e.g., via a combination of SFN, subframe number, slot number, and symbol number) of activating cell DRX for a cell (e.g., in a SIB). For example, the first network entity 1102 may transmit an indication of the absolute time to the first UE 1106 and the second UE 1108, where the absolute time is a specific time of when the second network entity 1104 is expected to perform an activation or deactivation of a cell DRX operation. Subsequently, after receiving the DCI format 2_9 (e.g., in a respective slot m for each UE), both the first UE 1106 and the second UE 1108 may assume that the cell DRX for the second cell (e.g., via the second network entity 1104) is activated or deactivated at the absolute time, which may be a same time for both the first UE 1106 and the second UE 1108.

### Example Timelines for Cell DRX and/or Cell DTX Activation or Deactivation with MAC-CE-Based Signaling

FIG. 12 depicts an example timeline 1200 for cell DRX and cell DTX activation that supports activating and deactivating cell DRX and cell DTX operations in accordance with aspects of the present disclosure. In some examples, the timeline 1200 may implement aspects of or may be implemented by aspects of FIGS. 1-11. For example, the timeline 1200 may represent a timeline of a network entity (e.g., a base station, a gNB, etc.) communicating with a UE with both UL and DL transmissions (e.g., DL transmissions occur from the gNB DL to the UE DL, and UL transmissions occur from the UE UL to the gNB UL), where the network entity and the UE represent examples of corresponding devices as described with reference to FIGS. 1-3 and 5-11.

In the example of FIG. 12 and as described with reference to FIGS. 6-9 and 11, the timeline 1200 may represent the network entity activating a cell DRX operation (e.g., on the gNB UL) and/or a cell DTX operation (e.g., on the gNB DL) starting at a slot 1202 after sending an indication to the UE in a slot 1204 (e.g., a slot m that includes an indication that the network entity is preparing to activate the cell DRX operation and/or the cell DTX operation). In the example of FIG. 12, transmission of the indication of the change and the cell DRX and cell DTX are performed on the same cell, but examples are not limited thereto (e.g., the transmission and the cell DRX/DTX are performed on different cells).

Additionally, in the example of FIG. 12, the indication of the change may be transmitted via a MAC-CE. In some embodiments, the MAC-CE may or may not carry an absolute time of cell DTX/DRX activation/deactivation. Additionally or alternatively, timing enhancements for using a MAC-CE to indicate a change in activation or deactivation for cell DRX and cell DTX may be insufficient because an alignment on the cell DTX/DRX activation/deactivation time is not pair-wise between the network entity and a single UE, but among the network entity and all UEs served by the network entity.

After receiving a MAC-CE, the UE is expected to respond with a HARQ ACK (e.g., transmitted in a slot 1206 at the UE and received in a slot 1208 at the network entity). For example, the UE may be expected to transmit the HARQ ACK in the slot 1206 on the UE UL, where the slot 1206 is equal to m+K_{offset}+K1 on the UE UL. The K_{offset} may represent a UE-specific scheduling time offset or a cell-specific scheduling time offset as described with reference to FIG. 10 (e.g., K_{offset} corresponds to a TA 1210 for the UE), and K1 may represent an offset between a DL slot where the MAC-CE is received at the UE (e.g., a slot 1212) and an UL slot where the HARQ ACK feedback for the HARQ ACK is expected to be sent (e.g., the slot 1206). In some embodiments and as used herein, K1 may be referred to as an acknowledgement feedback offset.

The network entity then may perform the activation or deactivation for cell DRX and/or cell DTX based on a delay 1214 (e.g., d slots or d+1 slots, where d is defined by the Table 1) after the HARQ ACK is received at the network entity (e.g., in the slot 1208). From a perspective of the network entity, cell DTX/DRX activation/deactivation may occur in the slot 1202 (e.g., gNB slot X for both DL and UL) with a delay that includes one or more timing offsets 1216 and the delay 1210 (e.g., K_{offset}+K1+d+1 slots) from the beginning of the slot 1204 (e.g., where the MAC-CE is transmitted).

From a perspective of the UE, cell DTX is activated or deactivated in a slot 1218 (e.g., UE DL slot X), and cell DRX is activated/deactivated in a slot 1220 (e.g., UE UL slot X). Because the UE applies the cell DRX change in activation or deactivation (e.g., in the slot 1220) prior to the network entity performing the change (e.g., in the slot 1202), the previously described issues may not exist of UL transmissions being unsuccessfully received at the network entity based on the network entity having already activated the cell DRX while the UL transmissions are in flight to the network entity.

However, for UEs that use respective UE-specific K_{offset} values (e.g., which have a higher priority than the cell-specific K_{offset} if both K_{offset} values are configured for a UE) and if the UE-specific K_{offset} values are different, the UEs may expect the activation or deactivation to occur at different times.

As described herein, the UEs may use the cell-specific K_{offset} for the HARQ ACK transmission in response to the reception of the MAC-CE that activates and/or deactivates a cell DTX operation and/or a cell DRX operation. Accordingly, by using the cell-specific K_{offset}, the UEs may expect the activation or deactivation to occur at a same time or an approximately same time.

FIG. 13 depicts an example timeline 1300 with a scheduling time offset for cell DRX and cell DTX activation that supports activating and deactivating cell DRX and DTX operations in accordance with aspects of the present disclosure. In some examples, the timeline 1300 may implement aspects of or may be implemented by aspects of FIGS. 1-12. For example, the timeline 1300 may represent a timeline of a network entity (e.g., a base station, a gNB, etc.) communicating with a UE with both UL and DL transmissions (e.g., DL transmissions occur from the gNB DL to the UE DL, and UL transmissions occur from the UE UL to the gNB UL), where the network entity and the UE represent examples of corresponding devices as described with reference to FIGS. 1-3 and 5-12.

In the example of FIG. 13 and as described with reference to FIGS. 6-9 and 11-12, the timeline 1300 may represent the network entity activating a cell DRX operation (e.g., on the gNB UL) and/or a cell DTX operation (e.g., on the gNB DL) starting at a slot 1302 after sending an indication to the UE in a slot 1304 (e.g., a slot m that includes an indication that the network entity is preparing to activate the cell DRX operation and/or the cell DTX operation). In the example of FIG. 13, transmission of the indication of the change and the cell DRX and cell DTX are performed on the same cell, but examples are not limited thereto (e.g., the transmission and the cell DRX/DTX are performed on different cells). Additionally, in the example of FIG. 13, the indication of the change may be transmitted via a MAC-CE.

In some embodiments, at the network entity, UL slots and DL slots may not be aligned and may differ by an offset 1306 (e.g., denoted as K_{mac}). In some embodiments and as used herein, the offset 1306 (e.g., K_{mac}) may be referred to as a downlink and uplink frame alignment offset. Additionally or alternatively, the offset 1306 (e.g., K_{mac}) may represent a RTT between the network entity and a UTSRP (e.g., a ULSRP). In some wireless communications networks (e.g., NTNs), a UTSRP may be used for facilitating communications between the network entity and UEs. At the UTSRP, DL slots and UL slots are aligned (e.g., within a TA offset which is a constant for a given scenario of coexistence with LTE and translates to a delay on the order of microseconds).

A UTSRP (e.g., a ULSRP) may represent a point (e.g., a network entity, a satellite, a base station, a virtual point between the satellite and the base station, etc.) where uplink time slots and downlink time slots are aligned. That is, the boundaries of both uplink and downlink slots with a same slot number coincide for a UTSRP, and the slots are of equal length. In some embodiments, a single network entity may include and/or configure one or more UTSRPs (e.g., and associated timelines) associated with or specific to the single network entity or one or more cells for the single network entity. Additionally or alternatively, a first network entity may include and/or configure at least a first UTSRP associated with or specific to the first network entity, and a second network entity may include and/or configure at least a second UTSRP associated with or specific to the second network entity. The timelines for the first UTSRP and the second UTSRP may or may not include aligned time slots between the two UTSRPs (e.g., the timelines for the first UTSRP and the second UTSRP are configured independently of each other).

In some embodiments, a UE can calculate one or more delays (e.g., a service link delay, a feeder link delay, etc.) using its own GNSS location, an ephemeris (e.g., for a network entity associated with the UTSRP), and a feeder link parameter (e.g., a ‘Common TA’), and then the UE can derive the timeline at the UTSRP for each network entity (e.g., if communicating with multiple network entities, satellites, base stations, cells, etc.). Accordingly, multiple UEs may derive essentially a same timeline (e.g., potentially with some negligible differences) at a UTSRP for a given network entity (e.g., satellite). Accordingly, based on the implementation of a UTSRP for communications from different network entities and/or cells, issues which occur because each UE looks at its local timelines (e.g., which may cause different UEs to identify different slot number values for activating or deactivating a cell DRX and/or cell DTX operation as described with reference to FIG. 11) may be mitigated.

When a UTSRP is utilized for the communications between a network entity and UEs (e.g., such that the offset 1306, K_{mac}, is considered or used in the communications), the cell DRX activation or deactivation time may be determined based on the techniques as described with reference to FIG. 12. For example, the UEs may use the cell-specific K_{offset} (e.g., scheduling time offset associated with a first cell) and an acknowledgement feedback offset (e.g., K1) for the HARQ ACK transmission (e.g., in a slot 1308) in response to the reception of a MAC-CE (e.g., received in a slot 1310 on the UE DL, which corresponds to a slot 1312 on the UE UL) that activates or deactivates cell DTX or cell DRX. Additionally, the UEs may expect that cell DRX activation or deactivation occurs in the UL slot X for the network entity (e.g., the slot 1302 on the gNB UL) with a delay from the beginning of the UL slot (e.g., a slot 1314) that corresponds (e.g., with a same slot number) to the DL slot where the MAC-CE is transmitted (e.g., the slot 1304), where the delay is based at least on a scheduling offset (e.g., the cell-specific K_{offset}). For example, the delay between the slot 1314 and the slot 1302 (e.g., on the gNB UL) may be equal to K_{offset}+K1+d+1 slots.

However, based on the misalignment between DL and UL slots at the network entity (e.g., DL and UL time offset at the network entity), the UL slot X for the network entity (e.g., the slot 1302 on the gNB UL) where the cell DRX activation or deactivation occurs may correspond to a DL slot 1316 (e.g., slots with a same slot number) not aligned with the UL slot X.

Accordingly, to align the activation or deactivation of cell DRX with the activation or deactivation of cell DTX, the network entity may further delay the activation or deactivation time for the cell DTX by the offset 1306 (e.g., K_{mac}) to occur at DL time slot X′ (e.g., the slot 1302 on the gNB DL). Additionally, the UEs may expect that cell DTX activation or deactivation occurs in the DL slot X′ for the network entity (e.g., the slot 1302) with a delay from the beginning of the DL slot where the MAC-CE is transmitted (e.g., slot m or the slot 1304), where the delay is based at least on the scheduling time offset associated with a first cell (e.g., the cell-specific K_{offset}) and a time interval representing the DL and UL time offset at the network entity. The time interval may be expressed by the parameter K_{mac} (e.g., the offset 1306). Accordingly, the delay between when the MAC-CE is sent (e.g., the slot 1304) and when the activation or deactivation of the cell DTX operation may be equal to K_{offset}+K1+d+K_{mac}+1 slots.

In some embodiments, when the cell where the MAC-CE is transmitted and the cell performing cell DRX and/or cell DTX operations are different, delaying the activation or deactivation of the cell DRX and/or cell DTX using the different offsets (e.g., K_{offset}, K1, K_{mac}, d, etc.) may not mitigate the described issues herein based on the offsets possibly being different across cells and UEs. Accordingly, when the cell where the MAC-CE is transmitted and the cell performing cell DRX and/or cell DTX operations are different, the network may use a combination of SIB- and MAC-CE-based signaling for performing an activation or deactivation of a cell DRX and/or cell DTX operation.

For example, the network entity may indicate (e.g., in a SIB) an absolute time (e.g., in terms of a combination of SFN, subframe number, slot number, and symbol index) at which cell DRX and/or cell DTX for a cell is expected to be activated or deactivated. The SIB carrying the absolute time may be sent via a same cell from which the MAC-CE is sent. Subsequently, the network entity may indicate (e.g., in the cell or a different cell) the activation or deactivation of a cell DRX and/or cell DTX for the cell in a MAC-CE, and after receiving the MAC-CE, the UE(s) may assume that the cell DRX and/or cell DTX for the cell is activated or deactivated at the indicated absolute time. In some embodiments, the absolute time may include a same or respective target times for performing a change in activation or deactivation of a cell DRX operation and for performing a change in activation or deactivation of a cell DTX operation.

The difference between the indicated absolute time and the beginning of the time slot when the MAC-CE is transmitted may be based on a scheduling time offset (e.g., the cell-specific K_{offset}) and a time interval representing the DL and UL time offset at the network entity (e.g., K_{mac}). The difference may be equal to or greater than K_{offset}+K1+D+K_{mac}+1 slots. In some embodiments, the difference may also consider the delay incurred in MAC-CE retransmissions. For example, the difference may be equal to R×(K_{offset}+K1+D+K_{mac}+1), where R is the maximum number of retransmissions. As described herein, the cell-specific K_{offset} and the K_{mac} may refer to the cell where the MAC-CE is sent.

FIG. 14 depicts an example of a cell DRX timeline 1400 for communications with multiple cells and using a UTSRP. In some examples, the cell DRX timeline 1400 may implement aspects of or may be implemented by aspects of FIGS. 1-13. For example, the cell DRX timeline 1400 may include a first network entity 1402, a second network entity 1404, a first UE 1406, and a second UE 1408, which may represent respective examples of corresponding devices as described with reference to FIGS. 1-3 and 5-13.

In the example of FIG. 14, DCI format 2_9 transmission (e.g., indicating a change in activation or deactivations of a cell DRX operation) and cell DRX occur on different cells that are originated from different network entities (e.g., satellites, base stations, etc.). For example, the first network entity 1402 may transmit the DCI format 2_9 via a first cell (e.g., a cell 1 used by the UEs for monitoring for DCI), and the second network entity 1404 may perform the cell DRX activation or deactivation via a second cell (e.g., a cell 2 doing the cell DRX).

As described previously with reference to FIG. 11, a DL time offset of the two cells may be different among the UEs, and the UEs may identify different values for when the second network entity 1404 activates or deactivates the cell DRX. Accordingly, based on the techniques described with reference to FIGS. 6 and 11 (e.g., to preempt or mitigate this issue of different DL time offsets), the network may signal an absolute time (e.g., via a combination of SFN, subframe number, slot number, and symbol number) of activating cell DRX for a cell (e.g., in a SIB). In some embodiments, techniques may be used to preempt or mitigate this issue of different DL time offsets in addition to or alternative to the signaling of an absolute time.

In the example of FIG. 14, the techniques for signaling of a cell DTX and/or cell DRX activation or deactivation via the first cell (e.g., using the DCI format 2_9) and then performing or applying the cell DTX and/or cell DRX activation or deactivation via the second cell may use UTSRPs associated with each cell. Using UTSRPs may change the view of the timing relationship between the two DL timelines from the respective UEs to the UTSRPs (e.g., for an NTN). That is, based on the techniques described in the example of FIG. 14, UEs may observe DL timelines for each cell at respective UTSRPs instead of at the respective UEs. Generally, the techniques described in the example of FIG. 14 may be referenced as UTSRP-based DCI signaling for cell DTX and/or cell DRX activation or deactivation.

Accordingly, in the example of FIG. 14, communications between the network entities and the UEs may include a UTSRP (e.g., a ULSRP) for facilitating the communications. As described with reference to FIG. 13, a UTSRP may represent a point (e.g., a network entity, a satellite, a base station, a virtual point between the satellite and the base station, etc.) where uplink time slots and downlink time slots are aligned (e.g., the boundaries of both uplink and downlink slots with a same slot number coincide for a UTSRP, the slots are of equal length, etc.). In some embodiments, the first network entity 1402 may configure or include a first UTSRP, and the second network entity 1404 may configure or include a second UTSRP. For example, a first UTSRP timeline may be configured for the first cell, and a second UTSRP timeline may be configured for the second cell. In some embodiments and in the example of FIG. 14, the UTSRP for each cell may be located at the respective network entities.

For example, as described with reference to FIG. 14, after a UE receives a command (e.g., DCI format 2_9) on a first cell to activate or deactivate cell DTX and/or cell DRX on a second cell in a first slot (e.g., slot m), the UE applies the cell DTX and/or cell DRX activation or deactivation change at the beginning of a subsequent slot (e.g., slot X), where the SCS of the slot X is with respect to the active DL or UL BWP of the second cell, and the slot X refers to the timeline at the UTSRP of the second cell (e.g., the second UTSRP timeline). Additionally, the slot X is a first slot whose beginning is no earlier than (e.g., same or after) the beginning of a slot m+d, where d (e.g., which translates to 3 ms in some examples) is the delay or the preconfigured delay described herein and m is the slot that includes the command based on the SCS associated with the channel (e.g., PDCCH) over which the command is sent, and slot m refers to the timeline at the UTSRP of the first cell (e.g., the first UTSRP timeline).

That is, the first UE 1406 and the second UE 1408 may monitor for and receive the DCI format 2_9 transmission from the first network entity 1402 via the first cell using the first UTSRP timeline (e.g., a first DL timeline at the first UTSRP). For example, the first UE 1406 and the second UE 1408 may monitor for and receive the DCI format 2_9 transmission in a slot 1410 of the first UTSRP timeline. In some embodiments, the slot 1410 may be a same slot (e.g., m=3) for the first UE 1406 and the second UE 1408 based on both UEs using the first UTSRP associated with the first network entity 1402 and/or the first cell to monitor for and receive the DCI format 2_9 transmission.

The UEs may then use the timelines at the UTSRPs of the respective cells to determine when the second network entity 1404 performs the cell DRX activation or deactivation. For example, the UEs may first identify or determine a slot m+d in the downlink at the UTSRP associated with the first cell (e.g., slot 6 of the first UTSRP timeline), where m is the slot containing the PDCCH of DCI format 2_9 received at the UEs (e.g., the slot 1410 or the slot 1412) and d is a delay 1414 (e.g., the preconfigured delay described herein).

Subsequently, the UEs may identify or determine a slot X in the downlink at the UTSRP associated with the second cell (e.g., slot 8 of the second UTSRP timeline, given by a slot 1416) that corresponds to the slot m+d in the downlink at the UTSRP associated with the first cell. In some embodiments, the slot 1416 (e.g., determined for the slot X) may be a same slot (e.g., X=8) for the first UE 1406 and the second UE 1408 based on both UEs using the second UTSRP associated with the second network entity 1404 and/or the second cell to activate or apply activation of cell DRX for the second cell. The UEs may then use the slot X as the uplink activation and/or application (e.g., at a corresponding uplink slot at the second UTSRP of the second cell that corresponds to the slot X in the downlink at the second UTSRP of the second cell based on the aligned slots of the second UTSRP) for cell DRX for the second cell.

Additionally or alternatively, the techniques and signaling described in the example of FIG. 14 may be used in addition to the previous techniques and signaling described previously. For example, one or more timing offsets (e.g., in addition to the delay 1414) described previously (e.g., such as the scheduling time offset associated with the first cell, the acknowledgement feedback offset, the downlink and uplink frame alignment offset, a maximum number of configured retransmissions of a MAC-CE, etc.) may be used with the UTSRP timelines described in the example of FIG. 14 to determine the slot X for activating or applying activation or deactivation of cell DRX and/or cell DTX for the second cell. That is, the slot X for activating or applying activation or deactivation of cell DRX and/or cell DTX for the second cell may be determined on the second UTSRP timeline based on one or more of the timing offsets described herein. Additionally or alternatively, the UEs may monitor for and receive a MAC-CE transmission from the first network entity 1402 via the first cell using the first UTSRP timeline, where the MAC-CE transmission is configured to activate or deactivate a cell DRX and/or cell DTX operation for the second cell on the second UTSRP timeline.

### Example Operations of a Network Entity for Activating or Deactivating a Cell DRX and/or Cell DTX Operation

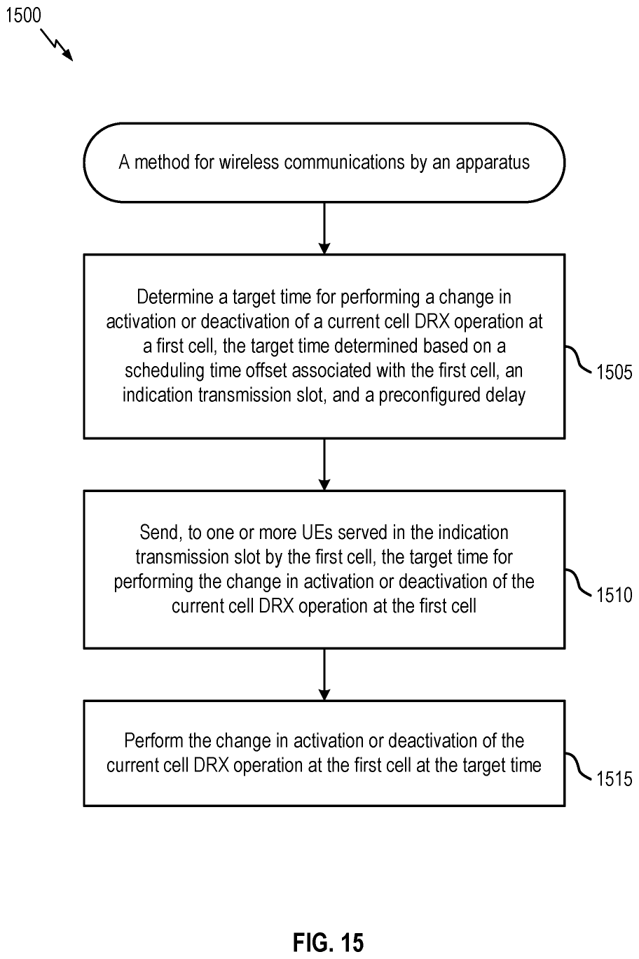

FIG. 15 shows a method 1500 for wireless communications by an apparatus, such as BS 102 of FIGS. 1 and 3, or a disaggregated base station as discussed with respect to FIG. 2.

Method 1500 begins at block 1505 with determining a target time for performing a change in activation or deactivation of a current cell DRX operation at a first cell, the target time determined based on a scheduling time offset associated with the first cell, an indication transmission slot, and a preconfigured delay.

Method 1500 then proceeds to block 1510 with sending, to one or more UEs served in the indication transmission slot by the first cell, the target time for performing the change in activation or deactivation of the current cell DRX operation at the first cell.

Method 1500 then proceeds to block 1515 with performing the change in activation or deactivation of the current cell DRX operation at the first cell at the target time.

In certain aspects, the target time for performing the change in activation or deactivation of the current cell DRX operation at the first cell is a beginning of a target slot, and wherein the target slot is a first slot that is not earlier than the indication transmission slot plus the preconfigured delay plus the scheduling time offset associated with the first cell.

In certain aspects, method 1500 further includes sending, to the one or more UEs served by the first cell, the scheduling time offset.

In certain aspects, method 1500 further includes sending, to the one or more UEs served by the first cell, the scheduling time offset in a SIB.

In certain aspects, the indication transmission slot is a downlink slot containing a PDCCH resource for DCI in format 2_9.

In certain aspects, the preconfigured delay is an integer number of slots, and wherein the integer number depends on a SCS of a downlink active bandwidth part of the first cell.

In certain aspects, method 1500 further includes sending, using a second cell and to the one or more UEs served in the indication transmission slot by the first cell, the target time for performing the change in activation or deactivation of the current cell DRX operation at the first cell, wherein the target time for performing the change in activation or deactivation of the current cell DRX operation at the first cell is indicated as an absolute time.

In certain aspects, the absolute time is indicated by a system frame number, subframe number, slot number, and symbol index of the first cell.

In certain aspects, the absolute time is indicated in a SIB of the second cell.

In certain aspects, method 1500 further includes determining the target time for performing the change in activation or deactivation of the current cell DRX operation at the first cell also based on an acknowledgement feedback offset.

In certain aspects, method 1500 further includes determining the target time for performing a change in activation or deactivation of a current cell DTX operation at the first cell based on the target time for performing the change in activation or deactivation of the current cell DRX operation and a downlink and uplink frame alignment offset.

In certain aspects, method 1500 further includes sending, to one or more UEs served in the indication transmission slot by the first cell, the target time for performing the change in activation or deactivation of the current cell DTX operation at the first cell.

In certain aspects, method 1500 further includes performing the change in activation or deactivation of the current cell DTX operation at the first cell at the target time.

In certain aspects, method 1500 further includes sending, to one or more UEs served in the indication transmission slot by the first cell, both the target time for performing the change in activation or deactivation of the current cell DRX operation at the first cell and the target time for performing the change in activation or deactivation of the current cell DTX operation at the first cell in a MAC-CE.

In certain aspects, method 1500 further includes determining the target time for performing the change in activation or deactivation of the current cell DRX operation at the first cell also based on a maximum number of configured retransmissions of the MAC-CE.

In certain aspects, method 1500 further includes determining the target time for performing the change in activation or deactivation of the current cell DTX operation at the first cell also based on the maximum number of configured retransmissions of the MAC-CE.

In certain aspects, the target time for performing the change in activation or deactivation of the current cell DRX operation at the first cell is determined by multiplying a sum of the indication transmission slot plus the preconfigured delay plus the scheduling time offset associated with the first cell plus the acknowledgement feedback offset plus one slot by the maximum number of configured retransmissions of the MAC-CE, and the target time for performing the change in activation or deactivation of the current cell DTX operation at the first cell is determined by multiplying a sum of the indication transmission slot plus the preconfigured delay plus the scheduling time offset associated with the first cell plus the acknowledgement feedback offset plus the downlink and uplink frame alignment offset plus one slot by the maximum number of configured retransmissions of the MAC-CE.

In certain aspects, the target time for performing the change in activation or deactivation of the current cell DRX operation at the first cell is a beginning of a target slot, wherein the target slot is a first slot that is not earlier than the indication transmission slot plus the preconfigured delay plus the scheduling time offset associated with the first cell plus the acknowledgement feedback offset plus one slot, and the target time for performing the change in activation or deactivation of the current cell DTX operation at the first cell is a beginning of an additional target slot, wherein the target slot is a first slot that is not earlier than the indication transmission slot plus the preconfigured delay plus the scheduling time offset associated with the first cell plus the acknowledgement feedback offset plus the downlink and uplink frame alignment offset plus one slot.

In certain aspects, method 1500 further includes sending, using a second cell and to the one or more UEs served in the indication transmission slot by the first cell, both the target time for performing the change in activation or deactivation of the current cell DRX operation at the first cell and the target time for performing the change in activation or deactivation of the current cell DTX operation at the first cell, wherein the target time for performing the change in activation or deactivation of the current cell DRX operation at the first cell and the target time for performing the change in activation or deactivation of the current cell DTX operation at the first cell are indicated as an absolute time.

In certain aspects, the absolute time is indicated by a system frame number, subframe number, slot number, and symbol index of the first cell.

In certain aspects, the absolute time is indicated in a SIB of the second cell.

In certain aspects, the apparatus comprises a base station.

In certain aspects, method 1500 further includes determining the target time for performing the change in activation or deactivation of the current cell DRX operation at the first cell based on a first timeline for an uplink synchronization reference point (e.g., UTSRP, ULSRP, etc.) associated with the first cell and a second timeline for an uplink synchronization reference point associated with the second cell.

In certain aspects, the indication transmission slot is a downlink slot on the second timeline containing a PDCCH resource for DCI in format 2_9, and the target time is a beginning of a target slot on the first timeline that is not earlier than an additional target slot on the second timeline, and wherein the additional target slot is a first slot on the second timeline that is not earlier than the indication transmission slot plus the preconfigured delay.

In certain aspects, the first timeline comprises uplink slots and downlink slots that are aligned in time for the uplink synchronization reference point associated with the first cell, and the second timeline comprises uplink slots and downlink slots that are aligned in time for the uplink synchronization reference point associated with the second cell.

In certain aspects, method 1500 may be performed by the apparatus to realize one or more technical effects or solutions to the aforementioned technical problem(s). For example, based on method 1500, the apparatus may increase a reliability of communications between the apparatus and an additional device (e.g., a UE) by increasing a probability that communications between the apparatus and the additional device are successfully communicated prior to the apparatus activating a current cell DRX operation. As described, the apparatus may perform a change in activation or deactivation of a current cell DRX operation at a target time that is determined based at least on a scheduling time offset with the current cell (e.g., K_{offset}), an indication transmission slot (e.g., slot m), and a preconfigured delay (e.g., d), where the scheduling time offset with the current cell and the preconfigured delay are used to delay the activation of the current cell DRX operation at the apparatus to increase the probability that the communications between the apparatus and the additional device are successfully communicated prior to the apparatus activating the current cell DRX operation. Additionally, based on method 1400, the apparatus may save energy for the network based on the apparatus employing cell DRX and/or cell DTX.

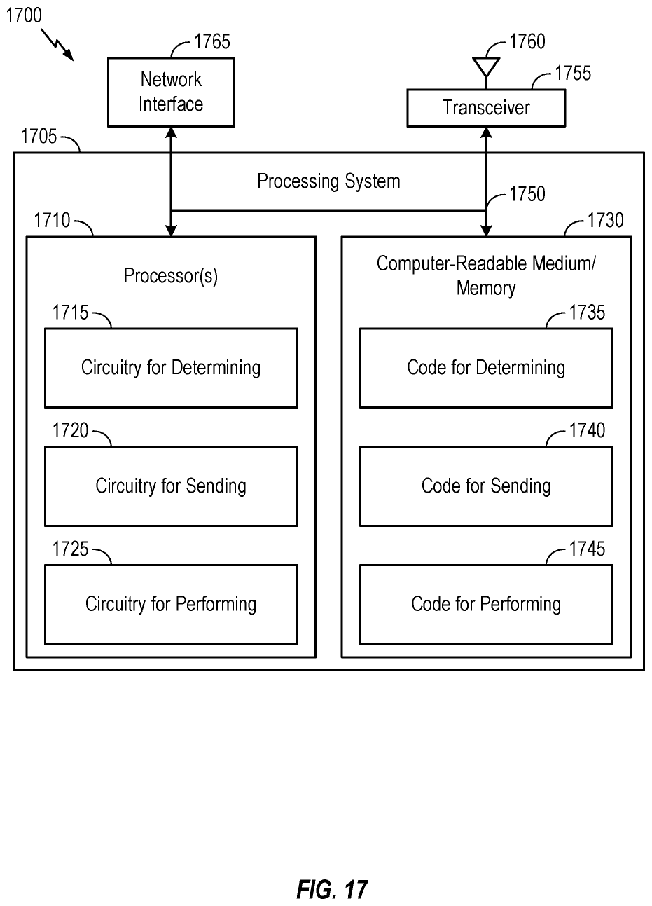

In certain aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

### Example Operations of a UE for Activating or Deactivating a Cell DRX and/or Cell DTX Operation

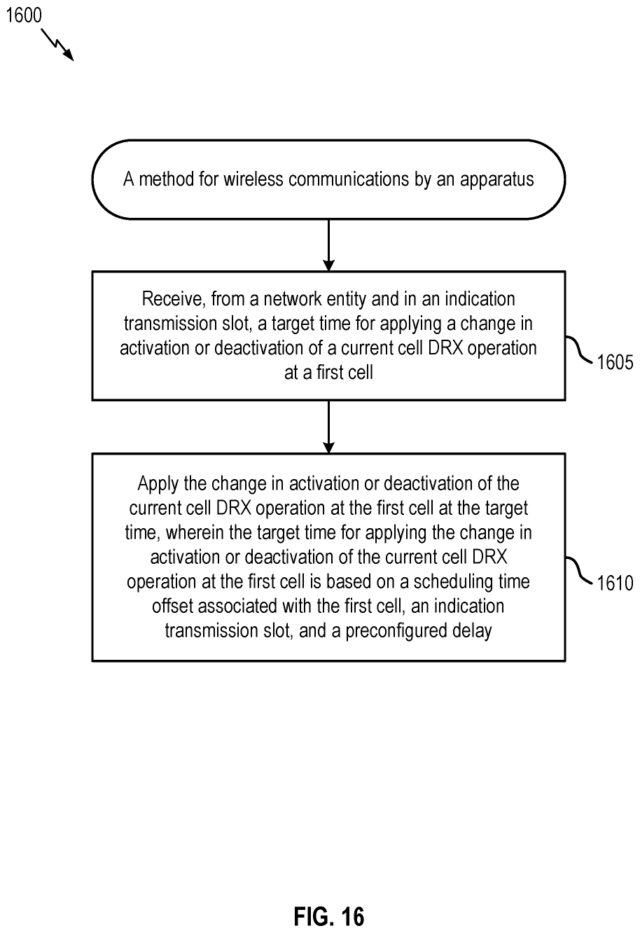

FIG. 16 shows a method 1600 for wireless communications by an apparatus, such as UE 104 of FIGS. 1 and 3.

Method 1600 begins at block 1605 with receiving, from a network entity and in an indication transmission slot, a target time for applying a change in activation or deactivation of a current cell DRX operation at a first cell.

Method 1600 then proceeds to block 1610 with applying the change in activation or deactivation of the current cell DRX operation at the first cell at the target time, wherein the target time for applying the change in activation or deactivation of the current cell DRX operation at the first cell is based on a scheduling time offset associated with the first cell, an indication transmission slot, and a preconfigured delay.

In certain aspects, the target time for applying the change in activation or deactivation of the current cell DRX operation at the first cell is a beginning of a target slot, and wherein the target slot is a first slot that is not earlier than the indication transmission slot plus the preconfigured delay plus the scheduling time offset associated with the first cell.

In certain aspects, method 1600 further includes receiving, from the network entity, the scheduling time offset.

In certain aspects, method 1600 further includes receiving, from the network entity, the scheduling time offset in a SIB.

In certain aspects, the indication transmission slot is a downlink slot containing a PDCCH resource for DCI in format 2_9.

In certain aspects, the preconfigured delay is an integer number of slots, and wherein the integer number depends on a SCS of a downlink active bandwidth part of the first cell.

In certain aspects, method 1600 further includes receiving, from the network entity via a second cell, the target time for the change in activation or deactivation of the current cell DRX operation at the first cell, wherein the target time for applying the change in activation or deactivation of the current cell DRX operation at the first cell is indicated as an absolute time.

In certain aspects, the absolute time is indicated by a system frame number, subframe number, slot number, and symbol index of the first cell.

In certain aspects, the absolute time is indicated in a SIB of the second cell.

In certain aspects, the target time for applying the change in activation or deactivation of the current cell DRX operation at the first cell is also based on an acknowledgement feedback offset. In certain aspects, method 1600 further includes receiving, from the network entity, a target time for applying a change in activation or deactivation of a current cell DTX operation at the first cell. In certain aspects, method 1600 further includes applying the change in activation or deactivation of the current cell DTX operation at the first cell at the target time. In certain aspects, the target time for applying the change in activation or deactivation of the current cell DTX operation at the first cell is based on the target time for applying the change in activation or deactivation of the current cell DRX operation and a downlink and uplink frame alignment offset.

In certain aspects, method 1600 further includes receiving, from the network entity and in the indication transmission slot, both the target time for applying the change in activation or deactivation of the current cell DRX operation at the first cell and the target time for applying the change in activation or deactivation of the current cell DTX operation at the first cell in a MAC-CE.

In certain aspects, method 1600 further includes sending, to the network entity, a HARQ ACK using the scheduling time offset associated with the first cell.

In certain aspects, the target time for applying the change in activation or deactivation of the current cell DRX operation at the first cell is also based on a maximum number of configured retransmissions of the MAC-CE, and the target time for applying the change in activation or deactivation of the current cell DTX operation at the first cell is also based on the maximum number of configured retransmissions of the MAC-CE.

In certain aspects, the target time for applying the change in activation or deactivation of the current cell DRX operation at the first cell is determined by multiplying a sum of the indication transmission slot plus the preconfigured delay plus the scheduling time offset associated with the first cell plus the acknowledgement feedback offset plus one slot by the maximum number of configured retransmissions of the MAC-CE, and the target time for applying the change in activation or deactivation of the current cell DTX operation at the first cell is determined by multiplying a sum of the indication transmission slot plus the preconfigured delay plus the scheduling time offset associated with the first cell plus the acknowledgement feedback offset plus the downlink and uplink frame alignment offset plus one slot by the maximum number of configured retransmissions of the MAC-CE.

In certain aspects, the target time for applying the change in activation or deactivation of the current cell DRX operation at the first cell is a beginning of a target slot, wherein the target slot is a first slot that is not earlier than the indication transmission slot plus the preconfigured delay plus the scheduling time offset associated with the first cell plus the acknowledgement feedback offset plus one slot, and the target time for applying the change in activation or deactivation of the current cell DTX operation at the first cell is a beginning of an additional target slot, wherein the additional target slot is a first slot that is not earlier than the indication transmission slot plus the preconfigured delay plus the scheduling time offset associated with the first cell plus the acknowledgement feedback offset plus the downlink and uplink frame alignment offset plus one slot.

In certain aspects, method 1600 further includes receiving, from the network entity via a second cell, both the target time for applying the change in activation or deactivation of the current cell DRX operation at the first cell and the target time for applying the change in activation or deactivation of the current cell DTX operation at the first cell, wherein the target time for applying the change in activation or deactivation of the current cell DRX operation at the first cell and the target time for applying the change in activation or deactivation of the current cell DTX operation at the first cell are indicated as an absolute time.

In certain aspects, the absolute time is indicated by a system frame number, subframe number, slot number, and symbol index of the first cell.

In certain aspects, the absolute time is indicated in a SIB of the second cell.

In certain aspects, the apparatus comprises a user equipment, and the network entity comprises a base station.

In certain aspects, the method 1600 may further include applying the change in activation or deactivation of the current cell DRX operation at the first cell based on a first timeline for an uplink synchronization reference point associated with the first cell and a second timeline for an uplink synchronization reference point associated with the second cell.

In certain aspects, the indication transmission slot is a downlink slot on the second timeline containing a PDCCH resource for DCI in format 2_9, and the target time is a beginning of a target slot on the first timeline that is not earlier than an additional target slot on the second timeline, where the additional target slot is a first slot on the second timeline that is not earlier than the indication transmission slot plus the preconfigured delay.

In certain aspects, the first timeline comprises uplink slots and downlink slots that are aligned in time for the uplink synchronization reference point associated with the first cell, and the second timeline comprises uplink slots and downlink slots that are aligned in time for the uplink synchronization reference point associated with the second cell.

In certain aspects, method 1600 may be performed by the apparatus to realize one or more technical effects or solutions to the aforementioned technical problem(s). For example, based on method 1600, the apparatus may increase a reliability of communications between the apparatus and an additional device (e.g., a network entity) by increasing a probability that communications between the apparatus and the additional device are successfully communicated prior to the additional device activating a current cell DRX operation. As described, the apparatus may apply a change in activation or deactivation of a current cell DRX operation for the additional device at a target time that is determined based at least on a scheduling time offset associated with the current cell (e.g., K_{offset}), an indication transmission slot (e.g., slot m), and a preconfigured delay (e.g., d), where the scheduling time offset associated with the current cell and the preconfigured delay are used to delay application of the activation of the current cell DRX operation for the additional device to increase the probability that the communications between the apparatus and the additional device are successfully communicated prior to the additional device activating the current cell DRX operation.

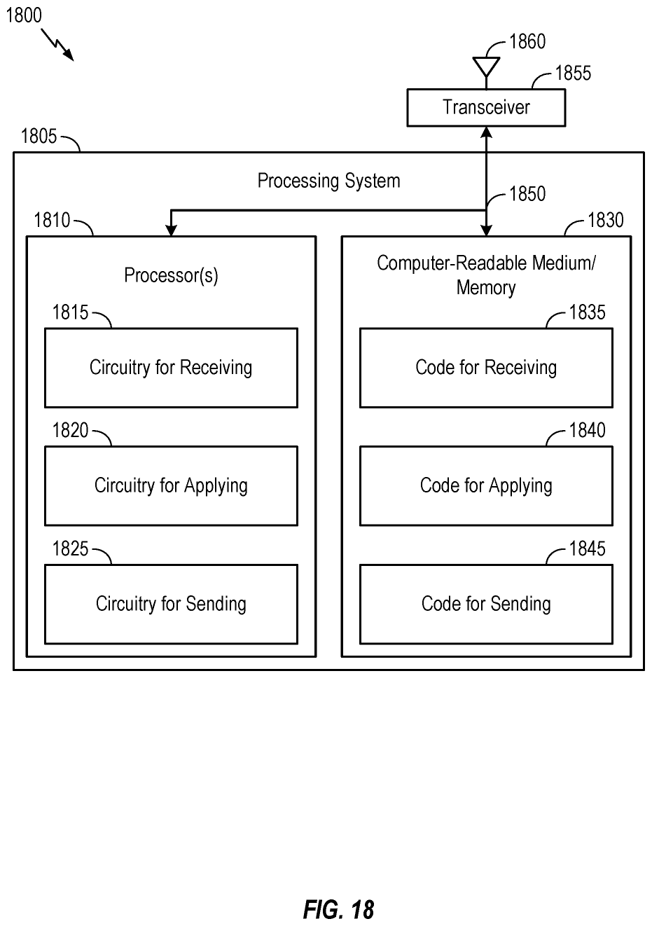

In certain aspects, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative operations are possible consistent with this disclosure.

### Example Communications Devices

FIG. 17 depicts aspects of an example communications device 1700. In some aspects, communications device 1700 is a network entity, such as BS 102 of FIGS. 1 and 3, or a disaggregated base station as discussed with respect to FIG. 2.

The communications device 1700 includes a processing system 1705 coupled to a transceiver 1755 (e.g., a transmitter and/or a receiver) and/or a network interface 1765. The transceiver 1755 is configured to transmit and receive signals for the communications device 1700 via an antenna 1760, such as the various signals as described herein. The network interface 1765 is configured to obtain and send signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1730 via a bus 1750. In certain aspects, the computer-readable medium/memory 1730 is configured to store instructions (e.g., computer-executable code) that when executed by the one or more processors 1710, enable and cause the one or more processors 1710 to perform the method 1500 described with respect to FIG. 15, or any aspect related to it, including any operations described in relation to FIG. 15. Note that reference to a processor of communications device 1700 performing a function may include one or more processors of communications device 1700 performing that function, such as in a distributed fashion.

In the depicted example, the computer-readable medium/memory 1730 stores code for determining 1735, code for sending 1740, and code for performing 1745. Processing of the code 1735-1745 may enable and cause the communications device 1700 to perform the method 1500 described with respect to FIG. 15, or any aspect related to it.

The one or more processors 1710 include circuitry configured to implement (e.g., execute) the code stored in the computer-readable medium/memory 1730, including circuitry for determining 1715, circuitry for sending 1720, and circuitry for performing 1725. Processing with circuitry 1715-1725 may enable and cause the communications device 1700 to perform the method 1500 described with respect to FIG. 15, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1755, antenna 1760, and/or network interface 1765 of the communications device 1700 in FIG. 17, and/or one or more processors 1710 of the communications device 1700 in FIG. 17. Means for communicating, receiving or obtaining may include the transceivers 332, antenna(s) 334, receive processor 338, AI processor 318, and/or controller/processor 340 of the BS 102 illustrated in FIG. 3, transceiver 1755, antenna 1760, and/or network interface 1765 of the communications device 1700 in FIG. 17, and/or one or more processors 1710 of the communications device 1700 in FIG. 17.

FIG. 18 depicts aspects of an example communications device 1800. In some aspects, communications device 1800 is a user equipment, such as UE 104 described above with respect to FIGS. 1 and 3.

The communications device 1800 includes a processing system 1805 coupled to a transceiver 1855 (e.g., a transmitter and/or a receiver). The transceiver 1855 is configured to transmit and receive signals for the communications device 1800 via an antenna 1860, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1830 via a bus 1850. In certain aspects, the computer-readable medium/memory 1830 is configured to store instructions (e.g., computer-executable code) that when executed by the one or more processors 1810, enable and cause the one or more processors 1810 to perform the method 1600 described with respect to FIG. 16, or any aspect related to it, including any operations described in relation to FIG. 16. Note that reference to a processor performing a function of communications device 1800 may include one or more processors performing that function of communications device 1800, such as in a distributed fashion.

In the depicted example, computer-readable medium/memory 1830 stores code for receiving 1835, code for applying 1840, and code for sending 1845. Processing of the code 1835-1845 may enable and cause the communications device 1800 to perform the method 1600 described with respect to FIG. 16, or any aspect related to it.

The one or more processors 1810 include circuitry configured to implement (e.g., execute) the code stored in the computer-readable medium/memory 1830, including circuitry for receiving 1815, circuitry for applying 1820, and circuitry for sending 1825. Processing with circuitry 1815-1825 may enable and cause the communications device 1800 to perform the method 1600 described with respect to FIG. 16, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1855 and/or antenna 1860 of the communications device 1800 in FIG. 18, and/or one or more processors 1810 of the communications device 1800 in FIG. 18. Means for communicating, receiving or obtaining may include the transceivers 354, antenna(s) 352, receive processor 358, AI processor 370, and/or controller/processor 380 of the UE 104 illustrated in FIG. 3, transceiver 1855 and/or antenna 1860 of the communications device 1800 in FIG. 18, and/or one or more processors 1810 of the communications device 1800 in FIG. 18.

### Example Clauses

Implementation examples are described in the following numbered clauses:

Clause 1: A method for wireless communications by an apparatus comprising: determining a target time for performing a change in activation or deactivation of a current cell DRX operation at a first cell, the target time determined based on a scheduling time offset associated with the first cell, an indication transmission slot, and a preconfigured delay; sending, to one or more UEs served in the indication transmission slot by the first cell, the target time for performing the change in activation or deactivation of the current cell DRX operation at the first cell; and performing the change in activation or deactivation of the current cell DRX operation at the first cell at the target time.

Clause 2: The method of Clause 1, wherein the target time for performing the change in activation or deactivation of the current cell DRX operation at the first cell is a beginning of a target slot, and wherein the target slot is a first slot that is not earlier than the indication transmission slot plus the preconfigured delay plus the scheduling time offset associated with the first cell.

Clause 3: The method of any one of Clauses 1-2, further comprising sending, to the one or more UEs served by the first cell, the scheduling time offset.

Clause 4: The method of Clause 3, further comprising sending, to the one or more UEs served by the first cell, the scheduling time offset in a SIB.

Clause 5: The method of any one of Clauses 1-4, wherein the indication transmission slot is a downlink slot containing a PDCCH resource for DCI in format 2_9.

Clause 6: The method of any one of Clauses 1-5, wherein the preconfigured delay is an integer number of slots, and wherein the integer number depends on a SCS of a downlink active bandwidth part of the first cell.

Clause 7: The method of any one of Clauses 1-6, further comprising sending, using a second cell and to the one or more UEs served in the indication transmission slot by the first cell, the target time for performing the change in activation or deactivation of the current cell DRX operation at the first cell, wherein the target time for performing the change in activation or deactivation of the current cell DRX operation at the first cell is indicated as an absolute time.

Clause 8: The method of Clause 7, wherein the absolute time is indicated by a system frame number, subframe number, slot number, and symbol index of the first cell.

Clause 9: The method of Clause 8, wherein the absolute time is indicated in a SIB of the second cell.

Clause 10: The method of any one of Clauses 1-9, further comprising: determining the target time for performing the change in activation or deactivation of the current cell DRX operation at the first cell also based on an acknowledgement feedback offset; determining the target time for performing a change in activation or deactivation of a current cell DTX operation at the first cell based on the target time for performing the change in activation or deactivation of the current cell DRX operation and a downlink and uplink frame alignment offset; sending, to one or more UEs served in the indication transmission slot by the first cell, the target time for performing the change in activation or deactivation of the current cell DTX operation at the first cell; and performing the change in activation or deactivation of the current cell DTX operation at the first cell at the target time.

Clause 11: The method of Clause 10, further comprising sending, to one or more UEs served in the indication transmission slot by the first cell, both the target time for performing the change in activation or deactivation of the current cell DRX operation at the first cell and the target time for performing the change in activation or deactivation of the current cell DTX operation at the first cell in a MAC-CE.

Clause 12: The method of Clause 11, further comprising: determining the target time for performing the change in activation or deactivation of the current cell DRX operation at the first cell also based on a maximum number of configured retransmissions of the MAC-CE; and determining the target time for performing the change in activation or deactivation of the current cell DTX operation at the first cell also based on the maximum number of configured retransmissions of the MAC-CE.

Clause 13: The method of Clause 12, wherein: the target time for performing the change in activation or deactivation of the current cell DRX operation at the first cell is determined by multiplying a sum of the indication transmission slot plus the preconfigured delay plus the scheduling time offset associated with the first cell plus the acknowledgement feedback offset plus one slot by the maximum number of configured retransmissions of the MAC-CE, and the target time for performing the change in activation or deactivation of the current cell DTX operation at the first cell is determined by multiplying a sum of the indication transmission slot plus the preconfigured delay plus the scheduling time offset associated with the first cell plus the acknowledgement feedback offset plus the downlink and uplink frame alignment offset plus one slot by the maximum number of configured retransmissions of the MAC-CE.

Clause 14: The method of Clause 10, wherein: the target time for performing the change in activation or deactivation of the current cell DRX operation at the first cell is a beginning of a target slot, wherein the target slot is a first slot that is not earlier than the indication transmission slot plus the preconfigured delay plus the scheduling time offset associated with the first cell plus the acknowledgement feedback offset plus one slot, and the target time for performing the change in activation or deactivation of the current cell DTX operation at the first cell is a beginning of an additional target slot, wherein the target slot is a first slot that is not earlier than the indication transmission slot plus the preconfigured delay plus the scheduling time offset associated with the first cell plus the acknowledgement feedback offset plus the downlink and uplink frame alignment offset plus one slot.

Clause 15: The method of Clause 10, further comprising sending, using a second cell and to the one or more UEs served in the indication transmission slot by the first cell, both the target time for performing the change in activation or deactivation of the current cell DRX operation at the first cell and the target time for performing the change in activation or deactivation of the current cell DTX operation at the first cell, wherein the target time for performing the change in activation or deactivation of the current cell DRX operation at the first cell and the target time for performing the change in activation or deactivation of the current cell DTX operation at the first cell are indicated as an absolute time.

Clause 16: The method of Clause 15, wherein the absolute time is indicated by a system frame number, subframe number, slot number, and symbol index of the first cell.

Clause 17: The method of Clause 16, wherein the absolute time is indicated in a SIB of the second cell.

Clause 18: The method of any one of Clauses 1-17, wherein the apparatus comprises a base station.

Clause 19: The method of any one of Clauses 1-18, further comprising determining the target time for performing the change in activation or deactivation of the current cell DRX operation at the first cell based on a first timeline for an uplink synchronization reference point associated with the first cell and a second timeline for an uplink synchronization reference point associated with the second cell.

Clause 20: The method of Clause 19, wherein the indication transmission slot is a downlink slot on the second timeline containing a PDCCH resource for DCI in format 2_9, and the target time is a beginning of a target slot on the first timeline that is not earlier than an additional target slot on the second timeline, and wherein the additional target slot is a first slot on the second timeline that is not earlier than the indication transmission slot plus the preconfigured delay.

Clause 21: The method of any one of Clauses 19-20, wherein the first timeline comprises uplink slots and downlink slots that are aligned in time for the uplink synchronization reference point associated with the first cell, and the second timeline comprises uplink slots and downlink slots that are aligned in time for the uplink synchronization reference point associated with the second cell.

Clause 22: A method for wireless communications by an apparatus comprising: receiving, from a network entity and in an indication transmission slot, a target time for applying a change in activation or deactivation of a current cell DRX operation at a first cell; and applying the change in activation or deactivation of the current cell DRX operation at the first cell at the target time, wherein the target time for applying the change in activation or deactivation of the current cell DRX operation at the first cell is based on a scheduling time offset associated with the first cell, an indication transmission slot, and a preconfigured delay.

Clause 23: The method of Clause 22, wherein the target time for applying the change in activation or deactivation of the current cell DRX operation at the first cell is a beginning of a target slot, and wherein the target slot is a first slot that is not earlier than the indication transmission slot plus the preconfigured delay plus the scheduling time offset associated with the first cell.

Clause 24: The method of any one of Clauses 22-23, further comprising receiving, from the network entity, the scheduling time offset.

Clause 25: The method of Clause 24, further comprising receiving, from the network entity, the scheduling time offset in a SIB.

Clause 26: The method of any one of Clauses 22-25, wherein the indication transmission slot is a downlink slot containing a PDCCH resource for DCI in format 2_9.

Clause 27: The method of any one of Clauses 22-26, wherein the preconfigured delay is an integer number of slots, and wherein the integer number depends on a SCS of a downlink active bandwidth part of the first cell.

Clause 28: The method of any one of Clauses 22-27, further comprising receiving, from the network entity via a second cell, the target time for the change in activation or deactivation of the current cell DRX operation at the first cell, wherein the target time for applying the change in activation or deactivation of the current cell DRX operation at the first cell is indicated as an absolute time.

Clause 29: The method of Clause 28, wherein the absolute time is indicated by a system frame number, subframe number, slot number, and symbol index of the first cell.

Clause 30: The method of Clause 29, wherein the absolute time is indicated in a SIB of the second cell.

Clause 31: The method of any one of Clauses 22-30, wherein: the target time for applying the change in activation or deactivation of the current cell DRX operation at the first cell is also based on an acknowledgement feedback offset, the method further comprises: receiving, from the network entity, a target time for applying a change in activation or deactivation of a current cell DTX operation at the first cell; and applying the change in activation or deactivation of the current cell DTX operation at the first cell at the target time, and the target time for applying the change in activation or deactivation of the current cell DTX operation at the first cell is based on the target time for applying the change in activation or deactivation of the current cell DRX operation and a downlink and uplink frame alignment offset.

Clause 32: The method of Clause 31, further comprising: receiving, from the network entity and in the indication transmission slot, both the target time for applying the change in activation or deactivation of the current cell DRX operation at the first cell and the target time for applying the change in activation or deactivation of the current cell DTX operation at the first cell in a MAC-CE; and sending, to the network entity, a HARQ ACK using the scheduling time offset associated with the first cell.

Clause 33: The method of Clause 32, wherein: the target time for applying the change in activation or deactivation of the current cell DRX operation at the first cell is also based on a maximum number of configured retransmissions of the MAC-CE, and the target time for applying the change in activation or deactivation of the current cell DTX operation at the first cell is also based on the maximum number of configured retransmissions of the MAC-CE.

Clause 34: The method of Clause 33, wherein: the target time for applying the change in activation or deactivation of the current cell DRX operation at the first cell is determined by multiplying a sum of the indication transmission slot plus the preconfigured delay plus the scheduling time offset associated with the first cell plus the acknowledgement feedback offset plus one slot by the maximum number of configured retransmissions of the MAC-CE, and the target time for applying the change in activation or deactivation of the current cell DTX operation at the first cell is determined by multiplying a sum of the indication transmission slot plus the preconfigured delay plus the scheduling time offset associated with the first cell plus the acknowledgement feedback offset plus the downlink and uplink frame alignment offset plus one slot by the maximum number of configured retransmissions of the MAC-CE.

Clause 35: The method of Clause 31, wherein: the target time for applying the change in activation or deactivation of the current cell DRX operation at the first cell is a beginning of a target slot, wherein the target slot is a first slot that is not earlier than the indication transmission slot plus the preconfigured delay plus the scheduling time offset associated with the first cell plus the acknowledgement feedback offset plus one slot, and the target time for applying the change in activation or deactivation of the current cell DTX operation at the first cell is a beginning of an additional target slot, wherein the additional target slot is a first slot that is not earlier than the indication transmission slot plus the preconfigured delay plus the scheduling time offset associated with the first cell plus the acknowledgement feedback offset plus the downlink and uplink frame alignment offset plus one slot.

Clause 36: The method of Clause 31, further comprising receiving, from the network entity via a second cell, both the target time for applying the change in activation or deactivation of the current cell DRX operation at the first cell and the target time for applying the change in activation or deactivation of the current cell DTX operation at the first cell, wherein the target time for applying the change in activation or deactivation of the current cell DRX operation at the first cell and the target time for applying the change in activation or deactivation of the current cell DTX operation at the first cell are indicated as an absolute time.

Clause 37: The method of Clause 36, wherein the absolute time is indicated by a system frame number, subframe number, slot number, and symbol index of the first cell.

Clause 38: The method of Clause 37, wherein the absolute time is indicated in a SIB of the second cell.

Clause 39: The method of any one of Clauses 22-38, wherein: the apparatus comprises a user equipment, and the network entity comprises a base station.

Clause 40: The method of any one of Clauses 22-39, further comprising applying the change in activation or deactivation of the current cell DRX operation at the first cell based on a first timeline for an uplink synchronization reference point associated with the first cell and a second timeline for an uplink synchronization reference point associated with the second cell.

Clause 41: The method of Clause 40, wherein the indication transmission slot is a downlink slot on the second timeline containing a PDCCH resource for DCI in format 2_9, and the target time is a beginning of a target slot on the first timeline that is not earlier than an additional target slot on the second timeline, and wherein the additional target slot is a first slot on the second timeline that is not earlier than the indication transmission slot plus the preconfigured delay.

Clause 42: The method of any one of Clauses 40-41, wherein the first timeline comprises uplink slots and downlink slots that are aligned in time for the uplink synchronization reference point associated with the first cell, and the second timeline comprises uplink slots and downlink slots that are aligned in time for the uplink synchronization reference point associated with the second cell.

Clause 43: One or more apparatuses, comprising: one or more memories comprising executable instructions; and one or more processors configured to execute the executable instructions and cause the one or more apparatuses to perform a method in accordance with any one of Clauses 1-42.

Clause 44: One or more apparatuses, comprising: one or more memories; and one or more processors, coupled to the one or more memories, configured to cause the one or more apparatuses to perform a method in accordance with any one of Clauses 1-42.

Clause 45: One or more apparatuses, comprising: one or more memories; and one or more processors, coupled to the one or more memories, configured to perform a method in accordance with any one of Clauses 1-42.

Clause 46: One or more apparatuses, comprising means for performing a method in accordance with any one of Clauses 1-42.

Clause 47: One or more non-transitory computer-readable media comprising executable instructions that, when executed by one or more processors of one or more apparatuses, cause the one or more apparatuses to perform a method in accordance with any one of Clauses 1-42.

Clause 48: One or more computer program products embodied on one or more computer-readable storage media comprising code for performing a method in accordance with any one of Clauses 1-42.

Clause 49: A network entity, comprising: a processing system that includes processor circuitry and memory circuitry that stores code and is coupled with the processor circuitry, the processing system configured to cause the network entity to perform a method in accordance with any one of Clauses 1-21.

Clause 50: A UE, comprising: a processing system that includes processor circuitry and memory circuitry that stores code and is coupled with the processor circuitry, the processing system configured to cause the UE to perform a method in accordance with any one of Clauses 22-42.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories comprising processor-executable instructions; and one or more processors configured to execute the processor-executable instructions and cause the apparatus to:
determine a target time for performing a change in activation or deactivation of a current cell discontinuous reception (DRX) operation at a first cell, the target time determined based on a scheduling time offset associated with the first cell, an indication transmission slot, and a preconfigured delay;
send, to one or more user equipments (UEs) served in the indication transmission slot by the first cell, the target time for performing the change in activation or deactivation of the current cell DRX operation at the first cell; and
perform the change in activation or deactivation of the current cell DRX operation at the first cell at the target time.

2. The apparatus of claim 1, wherein the target time for performing the change in activation or deactivation of the current cell DRX operation at the first cell is a beginning of a target slot, and wherein the target slot is a first slot that is not earlier than the indication transmission slot plus the preconfigured delay plus the scheduling time offset associated with the first cell.

3. The apparatus of claim 1, wherein the one or more processors are configured to cause the apparatus to send, to the one or more UEs served by the first cell, the scheduling time offset.

4. The apparatus of claim 3, wherein the one or more processors are configured to cause the apparatus to send, to the one or more UEs served by the first cell, the scheduling time offset in a system information block (SIB).

5. The apparatus of claim 1, wherein the indication transmission slot is a downlink slot containing a physical downlink control channel (PDCCH) resource for downlink control information (DCI) in format 2_9.

6. The apparatus of claim 1, wherein the preconfigured delay is an integer number of slots, and wherein the integer number depends on a subcarrier spacing (SCS) of a downlink active bandwidth part of the first cell.

7. The apparatus of claim 1, wherein:
the one or more processors are configured to cause the apparatus to send, using a second cell and to the one or more UEs served in the indication transmission slot by the first cell, the target time for performing the change in activation or deactivation of the current cell DRX operation at the first cell, and the target time for performing the change in activation or deactivation of the current cell DRX operation at the first cell is indicated as an absolute time.

8. The apparatus of claim 7, wherein the absolute time is indicated by a system frame number, subframe number, slot number, and symbol index of the first cell.

9. The apparatus of claim 8, wherein the absolute time is indicated in a SIB of the second cell.

10. The apparatus of claim 1, wherein the one or more processors are configured to cause the apparatus to:
determine the target time for performing the change in activation or deactivation of the current cell DRX operation at the first cell also based on an acknowledgement feedback offset;
determine the target time for performing a change in activation or deactivation of a current cell discontinuous transmission (DTX) operation at the first cell based on the target time for performing the change in activation or deactivation of the current cell DRX operation and a downlink and uplink frame alignment offset;
send, to one or more UEs served in the indication transmission slot by the first cell, the target time for performing the change in activation or deactivation of the current cell DTX operation at the first cell; and
perform the change in activation or deactivation of the current cell DTX operation at the first cell at the target time.

11. The apparatus of claim 10, wherein the one or more processors are configured to cause the apparatus to send, to one or more UEs served in the indication transmission slot by the first cell, both the target time for performing the change in activation or deactivation of the current cell DRX operation at the first cell and the target time for performing the change in activation or deactivation of the current cell DTX operation at the first cell in a medium access control-control element (MAC-CE).

12. The apparatus of claim 11, wherein the one or more processors are configured to cause the apparatus to:
determine the target time for performing the change in activation or deactivation of the current cell DRX operation at the first cell also based on a maximum number of configured retransmissions of the MAC-CE; and
determine the target time for performing the change in activation or deactivation of the current cell DTX operation at the first cell also based on the maximum number of configured retransmissions of the MAC-CE.

13. The apparatus of claim 12, wherein:
the target time for performing the change in activation or deactivation of the current cell DRX operation at the first cell is determined by multiplying a sum of the indication transmission slot plus the preconfigured delay plus the scheduling time offset associated with the first cell plus the acknowledgement feedback offset plus one slot by the maximum number of configured retransmissions of the MAC-CE, and
the target time for performing the change in activation or deactivation of the current cell DTX operation at the first cell is determined by multiplying a sum of the indication transmission slot plus the preconfigured delay plus the scheduling time offset associated with the first cell plus the acknowledgement feedback offset plus the downlink and uplink frame alignment offset plus one slot by the maximum number of configured retransmissions of the MAC-CE.

14. The apparatus of claim 10, wherein:
the target time for performing the change in activation or deactivation of the current cell DRX operation at the first cell is a beginning of a target slot, wherein the target slot is a first slot that is not earlier than the indication transmission slot plus the preconfigured delay plus the scheduling time offset associated with the first cell plus the acknowledgement feedback offset plus one slot, and
the target time for performing the change in activation or deactivation of the current cell DTX operation at the first cell is a beginning of an additional target slot, wherein the target slot is a first slot that is not earlier than the indication transmission slot plus the preconfigured delay plus the scheduling time offset associated with the first cell plus the acknowledgement feedback offset plus the downlink and uplink frame alignment offset plus one slot.

15. The apparatus of claim 10, wherein:
the one or more processors are configured to cause the apparatus to send, using a second cell and to the one or more UEs served in the indication transmission slot by the first cell, both the target time for performing the change in activation or deactivation of the current cell DRX operation at the first cell and the target time for performing the change in activation or deactivation of the current cell DTX operation at the first cell, and
the target time for performing the change in activation or deactivation of the current cell DRX operation at the first cell and the target time for performing the change in activation or deactivation of the current cell DTX operation at the first cell are indicated as an absolute time.

16. The apparatus of claim 15, wherein the absolute time is indicated by a system frame number, subframe number, slot number, and symbol index of the first cell.

17. The apparatus of claim 16, wherein the absolute time is indicated in a SIB of the second cell.

18. The apparatus of claim 1, wherein the apparatus comprises a base station.

19. A method for wireless communications, comprising:
determining a target time for performing a change in activation or deactivation of a current cell discontinuous reception (DRX) operation at a first cell, the target time determined based on a scheduling time offset associated with the first cell, an indication transmission slot, and a preconfigured delay;
sending, to one or more user equipments (UEs) served in the indication transmission slot by the first cell, the target time for performing the change in activation or deactivation of the current cell DRX operation at the first cell; and
performing the change in activation or deactivation of the current cell DRX operation at the first cell at the target time.

20. An apparatus configured for wireless communications, comprising: one or more memories comprising processor-executable instructions; and one or more processors configured to execute the processor-executable instructions and cause the apparatus to:
receive, from a network entity and in an indication transmission slot, a target time for applying a change in activation or deactivation of a current cell discontinuous reception (DRX) operation at a first cell; and
apply the change in activation or deactivation of the current cell DRX operation at the first cell at the target time,
wherein the target time for applying the change in activation or deactivation of the current cell DRX operation at the first cell is based on a scheduling time offset associated with the first cell, an indication transmission slot, and a preconfigured delay.

21. The apparatus of claim 20, wherein the target time for applying the change in activation or deactivation of the current cell DRX operation at the first cell is a beginning of a target slot, and wherein the target slot is a first slot that is not earlier than the indication transmission slot plus the preconfigured delay plus the scheduling time offset associated with the first cell.

22. The apparatus of claim 20, wherein the one or more processors are configured to cause the apparatus to receive, from the network entity, the scheduling time offset.

23. The apparatus of claim 22, wherein the one or more processors are configured to cause the apparatus to receive, from the network entity, the scheduling time offset in a system information block (SIB).

24. The apparatus of claim 20, wherein the indication transmission slot is a downlink slot containing a physical downlink control channel (PDCCH) resource for downlink control information (DCI) in format 2_9.

25. The apparatus of claim 20, wherein the preconfigured delay is an integer number of slots, and wherein the integer number depends on a subcarrier spacing (SCS) of a downlink active bandwidth part of the first cell.

26. The apparatus of claim 20, wherein:
the one or more processors are configured to cause the apparatus to receive, from the network entity via a second cell, the target time for the change in activation or deactivation of the current cell DRX operation at the first cell, and
the target time for applying the change in activation or deactivation of the current cell DRX operation at the first cell is indicated as an absolute time.

27. The apparatus of claim 26, wherein the absolute time is indicated by a system frame number, subframe number, slot number, and symbol index of the first cell.

28. The apparatus of claim 27, wherein the absolute time is indicated in a SIB of the second cell.

29. The apparatus of claim 20, wherein:
the apparatus comprises a user equipment, and
the network entity comprises a base station.

30. A method for wireless communications, comprising:
receiving, from a network entity and in an indication transmission slot, a target time for applying a change in activation or deactivation of a current cell discontinuous reception (DRX) operation at a first cell; and
applying the change in activation or deactivation of the current cell DRX operation at the first cell at the target time,
wherein the target time for applying the change in activation or deactivation of the current cell DRX operation at the first cell is based on a scheduling time offset associated with the first cell, an indication transmission slot, and a preconfigured delay.
